(19) United States
(12) Patent Application Publication
(10) Pub. No.: US 2007/0282930 A1
(43) Pub. Date: Dec. 6, 2007

(54) System and methodology for management and modification of human behavior within a goal-oriented program

(76) Inventors: Stephen S. Doss, San Carlos, CA (US); James J. Leftwich, Palo Alto, CA (US); Macksoud Khan, Palo Alto, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/786,264

(22) Filed: Apr. 11, 2007

Related U.S. Application Data
(60) Provisional application No. 60/791,710, filed on Apr. 13, 2006.

(51) Int. Cl. G04G 9/00; G06F 3/01

(52) U.S. Cl. 708/111; 708/132; 708/161

(57) ABSTRACT

A system and methodology for human behavior modification or maintenance implemented by electronic two way communication between a host computing device with software adapted to the task, and a user. The system employs collected data regarding user identity, availability, and behavior, and generates a customized program of sequential events during identified user available time segments on a plurality of days. The events are constantly re-allotted to the available time in given daily time segments through a feedback acknowledgment from the user subsequent to communications sent to the user about an event. This results in a constantly updated program based on user responses which continually adjusts for the remaining time in the time segment on any day during the program. The program is customizable by user input requests such as exclusion of time during the daily time segments, front loading or rear loading of daily events, program day extensions or reductions, starting a program day earlier than the regularly scheduled time, inserting plateaus to repeat days in a program, and backsetting or forwardsetting within a program profile. A shaping function may be employed to further customize the program.

This application claims priority from U.S. Provisional Patent Application Ser. No. 60/791,710 filed Apr. 13, 2006. The present invention relates to a system and methodology to support behavioral modification and/or maintenance within goal-oriented programs. More specifically, The present invention provides the means to enroll, or otherwise become a participant, in a guided and/or otherwise supported behavioral modification and/or maintenance program, which may be established in a standard or customized and/or individualized manner, and is dynamically reconfigurable throughout its active program calendar period, automatically by a computer program alone and/or interactively by a computer program in conjunction with actions and/or input from the Program Member, other people, and/or entities, systems, states, or signals. Program modification, customization, or tailoring may be based on simple needs such as determining when the person is awake or asleep, so as to know when to communicate and/or interact with them, or it may involve dynamic adjustments to the program parameters based on feedback of criteria key to insuring or optimizing success or compliance. The present invention can be embodied as a program-supporting software system, which can be in the form of a software application running on a fixed or mobile computing device, and/or as a software and/or hardware system whose constituent components may be divided and/or redundantly distributed among separate software and/or device components and connected via a network, and supported by a communications handler or server, and existing communication infrastructures, and/or combinations thereof.

### FIELD OF THE INVENTION

Typical behavioral modification and maintenance programs may include, but are not limited to, smoking cessation, dietary intake, exercise regimens, pharmaceutical drug regimens, behavioral reminders for the memory impaired, and even programs as diverse as psychological reinforcement, encouragement, and management or religious devotional prompting.

### BACKGROUND OF THE INVENTION

Many programs have been developed to change human behavioral patterns, and fall into numerous categories. Some aim to stop, reduce, and/or discourage certain behaviors, such as smoking, or alcohol or drug abuse. Others may have the goal of starting, increasing, and/or encouraging certain behaviors, such as exercise, dietary programs, or even positive mental hygiene such as positive thinking. Others are centered around making sure a schedule or regimen is followed, such as pharmaceutical regimens, or as an aid to those with memory impairments. Still others are centered around periodic rituals, such as prayer or meditation, as part of spiritual or religious tradition or practice.

There are numerous reasons why it is difficult for people to begin and maintain changes in their behaviors, behavioral responses, and behavioral patterns. In the case of chemical addictions or substance abuse, there are psychological and physical dependencies that cause various levels of withdrawal problems when a person attempts to stop usage altogether, or even reduce usage. Furthermore, because many behavioral patterns are habitual and ingrained, people are often not consciously aware of or focused on the associated behavioral activities, or lack thereof. Therefore, changes in behavior require some level of conscious focus and attention, and this itself is difficult to maintain, as people must add this new cognitive burden amidst the many life issues already competing for their real-time conscious attention. As a result, it's difficult to avoid lapsing into old patterns, either engaging in behaviors or activities which have negative consequences, or neglecting to engage in positive ones. This difficulty is compounded when the negative or positive behavioral activities occur or need to occur frequently throughout the day.

The World Health Organization estimated in 2001 that there were about 1.25 billion smokers in the world, representing about one third of the global population aged 15 and over. The vast majority of these smokers lived in the developing countries (800 million) and most were men (700 million). In China alone, there were about 300 million smokers. About one third of smokers in the developed world were women, compared to about one in eight in developing countries.

There was a relatively steady decline in cigarette consumption over the last three decades of the twentieth century in most first-world nations. By contrast, consumption in developing countries during this time increased by about 3.4% per annum. Increases in consumption were most rapid in China.

While smoking rates stabilized at 30% for the European region, as a whole (38% for men and 23% for women) over the last five years of this period, increases in population meant that the number of smokers rose. In 2001, 215 million of Europeans above the age of 15 were regular smokers: 130 million males and 85 million females. Aggressive marketing by the tobacco industry in the eastern part of the region, particularly among young people, women and the poor, offset the decreased consumption levels achieved in several western countries.

Ultimately, the numbers of smokers will continue to increase mainly due to expansion of the world's population. By 2030 it is estimated that there will be at least another 2 billion people in the world. Even if smoking prevalence rates fall, the absolute number of smokers are likely to increase. The expected continuing decrease in male smoking prevalence is estimated to be offset by the increase in female smoking rates, especially in developing countries.

Various reports indicate that 20-40% of smokers are actively trying to quit. Texting, or SMS (Short Message Service) usage patterns, according to Portio Research, driven by China and India's mobile phone markets, total SMS traffic in Asia is projected to increase from 540 billion messages in 2005 to over 1.2 trillion by 2010.

In 2005 Forrester Research predicts that the total European traffic from all mobile messaging types will grow by 92% over the next five years; the majority are forecast to come from person-to-person SMS, both in 2005 and at the end of 2010. They forecast that mobile messaging in Europe will grow to 278 billion messages by 2010.

For the United States, Forrester Research predicts that the many types of messaging will account for more than 126 billion messages total and $8.6 billion in revenue in 2009, with person-to-person SMS dominating these numbers.

For these reasons, a particularly preferred embodiment of the invention herein is targeted at smoking cessation. Research into behavioral modification programs involving addictions of various types uncovered some methods and strategies with proven results, but which also lacked certain capabilities or attributes that would support higher rates of success:

1. The Gradual Reduction Method

2. Positive reinforcement messages delivered through Text Messaging (SMS)

3. Giving up of control to an outside power

The Gradual Reduction Method (GRM) is an alternative to NRT (Nicotine Replacement Therapy) and other drug-based smoking cessation methods. With NRT, the smoker stops smoking abruptly, using medication in the form of patches, gums, inhalers or tablets to continue the supply of nicotine for up to 3 months to help overcome nicotine addiction. Another drug-based treatment, only available on prescription, is the anti-depressant bupropion (“Zyban”); a low dose in the last two weeks before quitting rises to full strength, taken for about 3 months after quitting. Research shows that both NRT and bupropion create extra problems for smokers: they have their own side-effects and, for the majority of smokers, do not deliver the hoped-for results.

The problem for most smokers, particularly those who have previously tried to stop, is that they know that abruptly stopping is going to be a painful and difficult experience, demanding significant willpower and resilience and would prefer to use a gradual reduction method. The Gradual Reduction Method allows both the nicotine and the associated behaviors and psychological components of smoking to be gradually reduced over time, thereby addressing the physiological, behavioral, and psychological aspects of smoking cessation in a more holistic manner.

Gradual reduction has been shown to be a comparatively effective procedure, if maintained and followed. Moderate-to-heavy smokers who reduce their consumption prior to their quit date are more likely to stop smoking; even those who continue to smoke consume on average 11.4 fewer cigarettes per day. Among relapsing patients, those who stop abruptly tend to return to their previous smoking levels while the gradual reducers relapse to significantly below their original levels.

Trying to stop smoking is a prime example of a need or desire to modify or stop a behavioral activity with associated negative consequences. However, there are currently a range of unmet human participant needs among available or marketed smoking reduction strategies, plans, and programs. Smoking cessation is a complex undertaking, in that it's goal is to reduce and/or stop a behavioral profile comprised of multiple physiological, physical, psychological, emotional, and mental components.

Physiologically, because nicotine is a highly addictive substance, smokers face the additional difficulties of physical dependency. In smoking cessation programs this presents issues involving how quickly the human body can reduce nicotine intake without causing intolerable discomfort. Real or perceived lack of control over the discomfort associated with reducing or halting nicotine intake can have a significant negative psychological and emotional effect on those pursuing smoking cessation, and lead to failure and/or greater levels of psychological, emotional, and physical discomfort and anxiety.

Additionally, there is a challenge of the inherent complexity, or granularity of a smoker's existing, natural daily behavioral profile and how it's supported through the specific mechanism of cigarettes. In NRT methods, nicotine patches, pieces of gum, or lozenges aim to cover the dependency portions of a smoker's behavioral profile, while removing the cigarette smoking portion altogether and immediately. But NRT means and methods cannot be made to fit the exact rate, dosage, granularity and flexibility of schedule and frequency. Nor can they incorporate and reductively control all the associated physical actions of a smoker's natural behavioral profile, such as getting a cigarette out of a package, lighting it, holding it, etc., since the participant is expected to forego these altogether from the start.

Physically, smokers go through elaborate, yet often unconscious physical movements that are associated with the oft-repeated ritual of smoking. Often smoking is linked to other common activities, states, or events in the smoker's life and day to day schedule. The physical behavioral patterns of a smoker are complex, unique to that person, and yet are spontaneously flexible according to the smokers conscious and unconscious whims. According to a 1995 study published in Cancer Medicine (.C. Decker Inc., Hamilton, Ontario, Canada), the use of “scheduled smoking times” can improve upon the Gradual Reduction Method. But creating and managing a schedule presents a significantly burdensome task for someone that's already going to be dealing with the stress associated with reducing or stopping an addiction and associated behavioral profile.

Mentally, a typical smoker's habit over time becomes a relatively unconscious activity, and one that places little demand or need for cognitive focus upon the smoker. Smoking is also generally an activity that occurs in many intervals throughout the day, and so keeping track mentally of the number of cigarettes smoked in order to control, cut down, or stop usage becomes an overwhelmingly difficult task. Even if a person decides that they will choose specific times or time intervals in which to smoke, it is inherently difficult to mentally and/or manually manage and maintain an ever-changing schedule to gradually reduce smoking over a calendar period through daily recalculation of fewer and fewer behavior events. It is even more mentally and/or manually daunting to dynamically recalculate intra-interval times within a specific day's schedule to flexibly adapt to the person's life activities while still maintaining a steady reduction program. Altogether these characteristics make smoking cessation a very difficult and elusive goal for most people to mentally and/or manually schedule and manage.

Many currently available mental and/or manually and/or self-managed behavioral reduction programs are either rigid in certain respects, lack flexibility, and/or are limited to one-size-fits-all or a-few-sizes-fit-all type approach to their programs, such that participants in these programs, with greatly varying individual behavioral patterns, are all forced to share or choose among a limited number of program lengths and/or daily schedules. This has serious disadvantages, since it means different individuals with different starting behavioral conditions will end up having significantly varying experiences, and this could be a factor in their success or failure.

Inflexibility and rigidity problems in current behavioral modification programs affect several aspects of participants' experience. One example are programs that have fixed calendar lengths, or a very limited number of calendar lengths. In such programs, those participants attempting to reduce (or otherwise modify) a greater starting behavioral profile, must do so in the same length of time as those participants attempting to reduce (or otherwise modify) a lesser starting behavioral profile. Simple logic dictates that these two participants will not be subjected to the same rate of behavioral modification, and hence will have potentially significantly differing experiences.

Another example of inflexibility and rigidity involves how accurately a behavioral modification and/or maintenance program can conform to a person's daily natural physiological, mental, and emotional behavioral profiles, both initially and throughout a program's calendar length. Habituated smokers have both a physiological addiction and a physical and mental behavioral habit or profile. Cigarettes provide the means to self-administer nicotine in small and accurate doses at any desired time throughout a smoker's day. The specific times and overall behavioral profile of even people smoking the same number of cigarettes daily may vary significantly. Some smokers may smoke more in the morning. Others may smoke more in the evenings. And all smokers vary in their own behavioral profiles to some degree from day to day, wanting to smoke more in certain situations, and less at other times, or needing to accommodate a plane flight or meetings, etc. Current smoking cessation methods and programs cannot easily match the resolution or granularity of a smoker's daily behavioral profile, as cigarettes offer a small dose and are simple to use when desired. By comparison, patches have a profile by which they release nicotine into the skin, but cannot do so at the exact same rate and pattern that a person may dynamically choose to smoke a cigarette. This presents a basic mismatch problem between an existing smoking behavioral profile and an NRT smoking cessation program profile, as such presents an opportunity for improvement in the field.

Some existing methods have been proposed to develop and modify smoker's habits with the ultimate goal of smoking cessation using a daily task schedule. U.S. Pat. No. 4,853,854 attempts this by having the participant or user of a device press a button every time they actually engage in the unwanted behavior and smoke. Over a period of time, dedicated to data collection, the system learns the number and time distribution of the person's habit, as they press the button every time they smoke. A profile model is then generated and employed as a base for computing and displaying or signifying time intervals when the user is allowed to smoke and times when they are not allowed to smoke (e.g.: a green light period, or “smoking is allowed at this time,” and corresponding red light period, or “smoking is not allowed at this time,” etc.). Over time, the number of times the “smoke now” state is active decreases and the corresponding time that the display or device is displaying “don't smoke now,” increases, thereby attempting to elicit behavior modification in the user who cedes control of the habit to the received messages.

The method described in U.S. Pat. No. 4,853,854 also includes the means for the participant or user to continue signaling actual smoking times via the same button, as were begun in the data collection period. However, these signals of actual smoking behavior are not described as being related to the scheduling of remaining alternating “smoking now allowed and smoking not allowed” periods, which are already scheduled for the day and unchanging. So there are two records, one a calculated and uneditable schedule for the current day, and a second being the accumulated recorded instances and corresponding timeline of signals when smoking actually occurred, as supplied by the button presses of the user. It is described that if the signals from the user via the button signifying actual smoking events vary significantly from the displayed smoke now/don't smoke now periods, that information can be used to recalculate and redistribute the displayed smoke now/don't smoke now periods for the following day, however the current day remains unchanged.

Present methods and systems leave open opportunities in the field for a significantly improved ability to dynamically, in real time, adjust the remaining portion of a user's or participant's day's program schedule from the moment of a signal or event forward to the end of the day. Such a means of dynamically adjusting the remaining portion of the user's day schedule greatly increases the accuracy and value of remaining signals to the user or participant, since, in smoking cessation the key figure is the daily allotment, more so than the exact time each allotted a behavioral event.

Records of a participant's program and effort profile, projected, in-progress, or completed or abandoned, is valuable. The privacy of participants is extremely valuable as well. A means to separate personal identification from the registration or program membership records of participants would be valuable, in that it allows privacy to be guarded, while Anonymized but real records containing behavioral profiles matched with a range of gathered contextual information and data on the user, participant, or program members.

Charts and records must often either be created and maintained manually and/or as a separate activity in a log or diary. This becomes a second, additional task participants must do if they want to track their progress, and so becomes an additional burden associated with the effort. The risk is either inaccurate or incomplete record keeping, or no record keeping altogether. This can significantly decrease a participant's chances for success in smoking cessation. The patches, pieces of gum, and lozenges currently used in NRT programs do not have the means to record how they're used and generate a program record. If such a record exists, it must be generated separately by the participant or those managing and administering the participant's program.

Furthermore, because current smoking cessation methods and programs do not incorporate the means to automatically and easily capture the actual behavioral profile of participants from moment to moment, they lack the means to accumulate, and Anonymized for privacy reasons, valuable data on the actual demographics, psychographics, sociographics, and behavioral profiles of smokers during cessation attempts. This ungathered data cannot therefore be used to advance human knowledge of the behavioral profiles of smokers before, during, and after cessation efforts, nor can it be used to improve the smoking cessation methods and programs themselves. Therefore there exists an opportunity for improvement in the field of data collection and record creation as related to behavioral modification and/or maintenance methods and programs.

Positive Reinforcement Through Text Messaging (SMS)

A recent study at Auckland University in New Zealand has indicated that sending positive reinforcement, though SMS messages is one of the most effective ways to help young smokers to stop smoking. 850 smokers, with an average age of 25, that had decided to quit took part in the research. Before their designated quit day the smokers in the study were sent messages five times a day containing messages such as: “Write down 4 people who will get a kick outta u kicking butt. Your mum, dad, m8s?” Similar messages continued to be sent to program participants for another four weeks. For a further five months three messages a week were sent. The results from these encouraging messages alone were impressive. Six weeks after the start of the experiment, 28% of the group that had received SMS messages of encouragement had quit, while only 13% of the group that had not received SMS-based encouragement messages, reported to have stopped smoking. However, the model employed in the Auckland University research program did not deal with nor aid in the calculation and/or administration of scheduling, nor was it described as being automated. A messaging method was similarly described in U.S. Pat. No. 5,967,789 which discloses a program of scheduled and sequential messages.

Giving Up of Control to an Outside Power

One of the fundamental values of a traditional “twelve step” program is turning over control to an outside power. In programs such as Alcoholics Anonymous, which was the original twelve step program, the phrase has a spiritual connotation, and the outside power is generally understood to meaning a supernatural or transcendent spiritual power. Twelve step programs also make great use of reliance on others associated with the program for support, guidance, and strength during moments of difficulty, doubt, or crises involving risk of relapse to the unwanted behavior or addiction.

Twelve-step programs are generally aimed at addiction behaviors such as alcoholism, where the nature of the intake and physiological and behavioral reaction to alcohol necessitate its being given up completely and immediately. NRT programs and “Cold Turkey” approaches to smoking cessation also both involve stopping cigarette smoking completely and immediately, though NRT seeks to replace the nicotine by a means other than smoking, and taper that down gradually.

Yet the initial and long-term success rate of most NRT methods of cessation are very low, with figures from different sources reported between 7% and 15% long-term quitting success rate. Though no cigarette smoking can be considered beneficial or desirable and the idea of stopping smoking immediately looks very good on its face, the failure rates of most existing cessation methods and programs are very high. And this failure leads to an even worse eventual outcome than continuing to smoke, but smoking less and less during a smoking cessation program, and that is outright failure and continuation of smoking long-term.

As such, there exists a need for a behavior modification system for humans that may be implemented using modern electronic communications systems and components. Such a system should provide a method of registering users and receiving their input over an electronic communication system such as the internet. Such a system should be capable of generating and initiating a customized behavior modification program, for each user, based on their respective input. Further, such a behavior modification program should be adapted to provide such a program in an organized fashion that is easily followed during a program profile having an initial finite plurality of days and with specific time segments on each day for implementation of a plurality of events requiring performance by the user and a subsequent input of a response.

Still further, such a behavior modification system should have a customized program profile which is adapted to schedule all user required actions and responses to daily time segments in which the user is awake, and free to perform both the task and response required. In the event of a delayed user response, such a system should provide immediate rescheduling of all remaining sequential tasks during the time segment.

Finally, such a behavior modification system, to maximize results, should allow for user input for changes to both the daily time segments as wells as the days in the program profile, and be adapted for immediate rescheduling of all events and days in the program profile in real time, to allow for work, illness, travel, or other common schedule changing events encountered by most users.

It is an additional object of this invention to provide such a behavior modification method and system that also allows for user input of request for changes to the program profile to allow for early or late rising, lengthening or shortening a day, excluding a portion of one or a plurality of days in the program profile, adding days to the program profile with a static number of tasks, and allowing the user to refrain from a task and save it for later implementation, after the occurrence of any of which a real time recalculation of the scheduling of each subsequent task in each daily time segment, is performed and implemented by the system to accommodate allowed user requests for change.

It is an object of this invention to provide a method of registering and receiving input from users over an electronic communication system such as the internet and thereafter initiating a behavior modification program based on that input.

It is a further object of this invention to provide such a behavior modification program that has highly customized program profiles for each user having a plurality of days in the profile with each day having time segments with a plurality of events requiring user response.

It is another object of this invention to allot daily time segments during the program profile for user interaction with the time segments being during determined active hours of the user.

It is a further object of this invention to accomplish such behavior modification by the communication of messaging to initiate each of a plurality of user-performed tasks during each daily time segment and to elicit a user response thereafter.

It is an additional object of this invention to provide such a behavior modification method to provide for real time recalculation and subsequent tentative allotment of the scheduling of each remaining event and related task in each daily time segment based on the timing of each elicited user response or acknowledgment following a communication.

It is an additional object of this invention to provide such a behavior modification method and system that also allows for user input of request for changes to the program profile to allow for early or late rising, lengthening or shortening a day, excluding a portion of one or a plurality of days in the program profile, adding days to the program profile with a static number of tasks, and allowing the user to refrain from a task and save it for later implementation, after the occurrence of any of which a real time recalculation of the scheduling of each subsequent task in each daily time segment, is performed and implemented by the system to accommodate allowed user requests for change.

With respect to the above description and background, before explaining at least one preferred embodiment of the invention in detail, it is to be understood that the invention is not limited in its application to the details of construction and to the arrangement of the components and/or steps set forth in the following description, or illustrated in the drawings. The various methods of employment of the invention herein described and disclosed, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for designing of other systems and methods and software and means for electronic communications for carrying out the several purposes of the present disclosed system and method for management and modification of human behavior. It is important, therefore, that the objects and claims be regarded as including such equivalent construction and methodology, insofar as they do not depart from the spirit and scope of the present invention.

### SUMMARY OF THE INVENTION

The present invention is a system implemented over an electronic communications network which provides the means to enroll, or otherwise become a participant, in a guided and/or otherwise supported behavioral modification and/or maintenance program. The program so implemented may be established in a standard or preferably customized and/or individualized manner, and is dynamically reconfigurable throughout its active program calendar period, automatically by a computer program alone and/or interactively by a computer program in conjunction with actions and/or input from the Program Member, other people, and/or entities, systems, states, or signals. Program modification, customization, or tailoring may be based on simple needs such as determining when the person is awake or asleep, so as to know when to communicate and/or interact with them, or it may involve dynamic adjustments to the program parameters based on feedback of criteria key to insuring or optimizing success or compliance. The present invention can be embodied as a program-supporting software system, which can be in the form of a software application running on a fixed or mobile computing device, and/or as a software and/or hardware system whose constituent components may be divided and/or redundantly distributed among separate software and/or device components and connected via a network, and supported by a communications handler or server, and existing communication infrastructures, and/or combinations thereof. User employed devices can include any type of modern communications device capable of two way communications with a remote computing device, such as a cell phone, PDA, two-way pager, laptop computer, home computer, network engaged television or similar devices where a message may be communicated to the user and the user may respond with a signal or other response thereafter.

Typical behavioral modification and maintenance programs may include, but are not limited to, smoking cessation, dietary intake, exercise regimens, pharmaceutical drug regimens, behavioral reminders for the memory impaired, and even programs as diverse as psychological reinforcement, encouragement, and management or religious devotional prompting. Once a user is enrolled or otherwise initiated, the program is then configured, managed and administered by software adapted to keeps track of, and dynamically adjusting the scheduling of Communication Events/Program Markers. Typically, user or Program Member is sent or given appropriate cues to engage in, increase, decrease, or refrain from, one or a plurality of specific behaviors. The cues may be via markers, instructions, permission, suggestions, encouragement, or admonishment communicated to the user as part of their active behavioral modification and/or maintenance program.

Some programs may be focused on terms of finite periods of time with specific end goals, and involve gradually or incrementally decreasing habitual behavior such as a smoking cessation program, or gradually or incrementally increasing behaviors such as a get physically fit program. Other programs, or later phases of programs, may have a term that aims to support and maintain ongoing periodic behaviors such as exercise or stretching, or psychological activities such as engaging in prayer or meditation a certain number of times throughout the day. Such maintenance programs may have a term that is permanent or be of indeterminate length.

By providing a simple and convenient means to enroll in such externally managed and guided programs, and utilizing extant fixed and/or mobile computing and communication technologies, users are freed from many of the mental and psychological challenges which complicate compliance with, and adherence to, such behavioral modification and/or maintenance programs. As such, the present invention establishes a new and valuable means to direct and support a user's participation in behavioral modification and/or maintenance programs which are known to be successful if properly followed.

The disclosed method and implementation thereof allows for employment of one or a combination of a number of separately proven successful approaches such as the Gradual Reduction Method, SMS-based encouragement, and turning over personal control to an outside power. The disclosed method achieves excellent results through the employment and integration of a combination of communication-based direction and associated user acknowledgment and feedback, and with the management and provision of behavior-inducing communications (Communication Events/Program Markers, commands, suggestions, permission, allowances, encouragement, advice, signals, cues, actions, feedback, etc.) adapted to produce the desired target behavior, results, or goal over time. Furthermore, multiple concurrent users who may or may not be directly related to or associated with one another (for example, a smoking cessation program in combination with a meditation regimen, etc.) can be participating in separate simultaneous or overlapping programs of the disclosed method with each supported in an individualized fashion by the disclosed invention herein.

The behavior-directing component of the present invention's integrated system guides the participant's, or subscribing member's behavior via round-trip Communication Events/Program Markers, each requiring an associated reply in the form of a return message and/or equivalent acknowledgment user initiated signal, such as a button push. Thus, the subscribing user is benefited by being free of the need to redirect mental focus from the activities and issues of normal daily life, and does not need to expend the extra cognitive effort and overall bother of computing and administering an ever-changing schedule as is associated with a gradual reduction method. The effort and stress associated with computing and administering a behavioral modification schedule mentally and/or manually by a person is, by itself, a burden that can have a deleterious effect on the effectiveness and success of a behavioral modification and/or maintenance program.

The concept of giving up personal control to an outside power can also be interpreted in a different and non-religious or non-spiritual way in behavioral modification and/or maintenance programs where the user is not required to quit the associated behavior immediately, or “cold turkey.” In the present invention, where the ever-changing reduction schedule is calculated and administered by a computer program that delivers behavior management or guidance messages and/or signals to which the participant replies with an acknowledgment signal, and in which the participant no longer needs to be burdened by the necessary hassle and bother of calculating and managing an ever-changing reduction schedule, the computer can thus take on the role of “a higher power” that control or responsibility or hassle can be “given up to,” or, more specifically, “taken care of by.”

The behavior-directing component of the present invention is also dynamically, flexibly, and adaptively programmable to prompt the member's behavior in gradually reducing (or increasing, or maintaining) steps, depending upon the nature of the program type and desired goals, and do so in a manner that's both firm and yet flexibly adjustable to fit a range of typical daily schedule variances that occur in peoples' lives, while keeping them on the overall behavioral modification and/or maintenance track. This dynamic programmability can also be driven by, or informed by, user input or tracked data during the active program period from tracked behavior, signals, requests, Program Input Codes, and/or programmed automatic or manually configured or requested changes to the full calendar-length Program Profile or daily Program Day Schedule Profile.

Furthermore, the behavior-directing component of the present invention can be further shaped, such as the conforming of a reduction slope to a sigmoidal S-curve shape, where the Program Member or user, is gradually brought onto the program with a reduced rate of Communication Events/Program Markers, and thereafter gradually transitions into the higher standard rate of Communication Events/Program Markers during the middle section of the program. The user then finally transitions into another reduced rate of Communication Events/Program Markers at the end of the program.

Active Program Periods, which includes both the whole Active Program Calendar Period as well as the daily Program Day Schedules, can be lengthened, shortened, or otherwise modified in real time, based on input in the form of information, direction, signals, conditions, or other stimuli at both the initial program setup as well as throughout the duration of the program. As such, the behavior-directing component of the present invention is very flexible and adjustable, both in how programs are initially customized and configured at the start of programs, as well as being dynamically adjustable and customizable throughout the program's duration to better fit the needs of individual participants, and thus be more effective. This flexible customization and ongoing dynamic adjustability of the behavior-directing component of the present invention enables it to most effectively serve widely varying behavioral and scheduling conditions and needs.

The present invention can be configured to effectively support a behavioral modification program based on the Gradual Reduction Method, but can also be used to work just as well for programs that prompt greater, increasing, or ongoing compliance with activities, such as exercise, or ongoing programs aimed at maintaining a regulated compliance of actions or regimen.

In one preferred embodiment of a program for smoking cessation, which would also apply to smokeless tobacco usage cessation, an individual or user, or others acting on behalf of the individual, registers and/or subscribes to a program service via a device or computer software application, the web, phone, WAP, or other enabling computing and/or communication technology. During this registration, the individual user enters his or her contact information such as their name and address and optionally transactional or payment information, additional contact information, such as but not limited to a mobile phone or computing device number, pager number, email addresses, etc. Also entered would be information concerning the present state of their habit such as an average number of cigarettes smoked, or equivalent nicotine intake, on a daily basis. Further information entered would include the average time of day that he or she wakes, or has a first cigarette and goes to sleep, or has a last cigarette. This daily information would also include separate information for the weekdays and weekends, and potentially separately for any day of the week. Once registered, the individual user becomes a Program Member.

The software is adapted to employ this key information from a Program Member's registration in order to choose a Program Profile and/or Program Day Schedule Profile Template. The template can then be further configured, customized, or tailored such that the user's basic Program and/or Program Day Schedule Profiles fit the waking, or Active Program Day Schedule and smoking reduction needs of the Program Member. Such further customization and individual tailoring can be applied to the initial Program and/or Program Day Schedule Profiles either directly by, and/or requested to be done by, the Program Member, others acting on behalf of the Program Member, the administering service and/or its representatives by interacting with the adjustable Program and/or Program Day Schedule Profile parameters. Similar further customization and individual tailoring can be applied to the Program and/or Program Day Schedule Profiles during the Active Program Calendar Schedule by the software adapted to the task running on the computer, by monitoring an Active Program and calculating or choosing reconfiguration action responses and which will automatically reconfigure the Program Member's Program and/or Program Day Schedule Profiles.

Subsequent to registration and/or equivalent initialization and setup, the created program is thereafter active over an ensuing period of time, which is determined by choosing a user appropriate amount of time for a maintenance-oriented program, or, in behavioral reduction or increase programs by taking the Program Member's declared current behavioral pattern and calculating a corresponding period of time over which the behavior will be respectively decreased or increased at a standard or selected rate. This calculation will cause Active Program Calendar Periods to vary in length among Program Members. Reduction Program Members or users who initially start their programs with higher numbers of behavioral events per day, will have longer Active Program Calendar Periods than those Program Members that start with fewer initial behavioral events per day. The inverse is true of Increase Program Members, whose length of Active Program Calendar Period will be determined by the difference between how many behavioral events per day they wish to reach and whatever lower number of behavioral events per day they initially start with. With a model centered around the rate or rates of change, all Program Members will be assured initial Program and Program Day Schedule Profiles which deliver a similar and/or optimized experience or rate of behavioral change over time. In Reduction and Increase Programs, this experience or rate of behavioral change over time can be seen as a downward moving or upward moving slope, respectively. The present invention provides the means to configure Reduction and Increase Programs so that all Program Members are Decreasing or Increasing at approximately the same base rate, prior to subsequent reconfiguration of Program and/or Program Day Schedule Profiles. This contrasts with programs that have one or a few fixed program period lengths, and which have the drawback of having to fit differing amounts of behavioral change into one or a few standard program period lengths, and make it impossible for all members to start with the same or optimized rate of behavioral change.

Over an ensuing Active Program Calendar Schedule (the length of which will vary according to the Program Member's stated initial behavioral information, the goal of the Program, and the optimized rate of behavioral change and/or maintenance calculated and/or chosen to configure a Program and/or Program Day Schedule Profile that will most effectively support that Program Member in reaching the desired target goal), the computer run software will communicate through a server or other device adapted to the task, and will send a Communication Event/Program Marker to the Program Member at computed intervals effectively letting him or her know that it's time when they may choose to smoke a cigarette (this can also be seen as permission having been granted to smoke one cigarette, in case the Program Member cannot or does not wish to smoke at the exact time of receipt of communication). Either immediately upon receipt, or after the Program Member has smoked the cigarette allowed/prompted by the Communication Event/Program Marker, a user generated response is generated in the form of a return reply or acknowledgment Communication Event/Program Marker which is communicated to the computer running the software adapted to the task herein. The response acknowledges that the Communication Event/Program Marker was received and/or the associated cigarette has been smoked, or that the program marker has been acknowledged. Receipt of this acknowledgment feedback then enables the computer software to determine when the next interval and associated Communication Event will occur, and hence when the next Communication Event/Program Marker will be sent or displayed to the Program Member. This calculation is based on the waking hours, or normal times for the Program Member's first and last cigarettes of the day, and number of scheduled Communication Events/Program Markers or cigarettes remaining in that day's schedule. If more than one calculated Communication Event/Program Marker interval has passed without receipt of Program Member confirmation reply or equivalent acknowledgment feedback, the remaining Communication Event/Program Marker Intervals for the day is recalculated (closer together) by the software so as to still provide the Program Member with the number of cigarettes/correct total amount of nicotine and associated smoking behavior required/allotted for that day in the Program Profile. This ability of the software to adapt the subsequent events allows great flexibility on the part of the user or Program Member to smoke more of the allotted cigarettes later in the day, or to schedule around unanticipated time frames where the user is unable to smoke.

This recalculation by the software will be done as necessary, as Communication Event/Program Marker intervals pass without receipt of Program Member acknowledgment feedback. This accommodates Program Members being on long airplane flights, or stuck in facilities that don't allow smoking for extended periods of any day. However, the Program Member will never receive a Communication Event/Program Marker prompting/allowing more than one cigarette at a time, so receipt of the Program Member's acknowledgment feedback will be required for every Communication Event/Program Marker received and associated cigarette smoked, or that the program marker has been acknowledged, prior to the next Communication Event/Program Marker interval being calculated and sent or displayed to the Program Member.

Further steps may be taken by the computer software adapted to the task herein to avoid the problem of Program Member anticipation anxiety associated with fixed and known regular communication intervals. This is done by sending out each of the communications at somewhat random times, centered around each calculated communication interval. This further reinforces the turning-over-of-control to an outside power concept in the user. The number of communications (Communication Events/Program Markers) and cigarettes to be smoked per day will decrease and Communication Event intervals will increase over the thirty-day or other term program period. Subsequently, the Program Member may enter a maintenance regimen, where Communication Events/Program Markers and guidance are aimed at maintaining or securing gains made during an initial cessation program (or as appropriate for other kinds of programs).

Customization and individual Program Member Program individualization is supported by the present invention by means of a range of Program Profile and Program Day Schedule Profile reconfiguring methods which when applied to a Program Member's current Program and/or Program Day Schedule Profile, result in a subsequent reconfiguration of scheduling and associated Communication Event/Program Marker handling or in Flagging or otherwise associating information, notation, signals, events, or states with particular points or segments of a Program Member's Program Record and/or individual Program Day Schedule Records. These include but are not limited to the following Program Profile and Program Day Schedule Profile Reconfiguration and Flagging methods:

Shaping a Program Profile

The plotting of change in the number of Communication Events/Program Markers from day to day along the length of a behavioral and/or maintenance program is its Program Profile. In the simplest possible Program Profile involving, for example, a Reduction or Increase Program, this would be represented by a straight downward or upward pointing slope, respectively. Similarly, in the simplest form of a Maintenance Program Profile, the plotting would be a straight horizontal line over time.

The systems and methodologies of the present invention provide the means to modify a simple straight line Program Profile by employing software adapted to the task to apply a shaping function. Shaping functions include, but are not limited to, curves, stairsteps, plateaus, sequential shaped and unshaped sections of the Program Profile, and combinations thereof. These shaping functions are themselves variable, as differing values are inserted into their respective functional variables.

Inserting a Plateau into a Program Profile

One important need among participants in any strenuous or stressful undertaking is the ability to stop and hold steady, or rest before continuing the activity or endeavor. Behavioral modification and/or maintenance programs are no exception to this need, and the inflexibility of rigid behavioral modification and/or maintenance programs can lead to acute discomfort or weakness of resolve, and in turn can lessen the effectiveness of the program or lead to ultimate program failure.

The systems and methodologies of the present invention provide a means to insert a Plateau into a Program Profile, where the current level of daily Communication Events/Program Markers are held at the current number for a specified period of days, whereupon the Plateau would end and the Program Profile would continue on as it would have from the point where the Plateau was inserted. Plateaus in an active Program Profile can be specified and inserted through requests in the form of Redistribution Program Input Codes. In the present invention, a system and methodology is provided by which Plateau insertions can be requested by the users or Program members, others, or automatically by means of signals generated upon recognition of specified events, conditions, and/or states.

Redistribution of Communication Events/Program Markers within a Program Day Schedule

In a Program Day Schedule Profile, the day's allotted Communication Events/Program Markers are tentatively scheduled at intervals between the Wake/Start/Begin/First Communication Event/Program marker Date/Time and the Sleep/Stop/End/Last Communication Event/Program Marker Date/Time. In the simplest distribution, these intervals between Communication Events/Program Markers are all equal in length of time, meaning that they are equally distributed. The systems and methodologies of the present invention provide a means to redistribute Communication Events/Program Markers within Program Day Schedules in configurations other than simple equal distributions. Redistribution methods include, but are not limited to combinations of compression and expansion of intervals between Communication Events/Program Markers, such as shorter intervals toward the beginning of the Program Day Schedule and longer intervals toward the end of the Program Day Schedule. Such reconfiguration of a Program Day Schedule could fit the needs of Program Members who require or desire more of their daily allotted behavioral events during a particular portion of the Program Day Schedule.

Communication Events/Program Markers in an active Program Day Schedule Profile can be redistributed in a variety of ways through requests in the form of Redistribution Program Input Codes. In the present invention, a system and methodology is provided by which Communication Event/Program Marker redistribution can be requested by the users or Program Members, others, or automatically by means of signals generated upon recognition of specified events, conditions, and/or states.

Adding Time to Extend or Deleting Time to Shorten a Program Day Schedule

While Program Day Schedule Profiles have a set Wake/Start/Begin/First Communication Event/Program Marker Date/Time and a corresponding Sleep/Stop/End/Last Communication Event/Program Marker Date/Time, there are days when Program Members may wish to extend or shorten the hours during which that day's Communication Events/Program Markers will be distributed and sent or displayed to them, by changing the time of the last scheduled Communication Event/Program Marker of the day's Program Day Schedule.

The systems and methodologies of the present invention provide a means to change the Sleep/Stop/End/Last Communication Event/Program Marker Date/Times of a Program Member's remaining Program Day Schedules by moving them forward or backward in time. All of the remaining Sleep/Stop/End/Last Communication Event/Program Marker Date/Times for a Program can be set to a new different time by changing the Sleep/Stop/End/Last Communication Event/Program Marker Date/Time variable in the Program Member's Program Record. Individual Sleep/Stop/End/Last Communication Event/Program Marker Date/Times for a particular day's Program Day Schedule can be moved forward or backward in time through requests in the form of Add Time and Delete Time Program Input Codes.

In the present invention, a system and methodology is provided by which Adding or Deleting Time from a Program Day Schedule can be requested by Program members, others, or automatically by means of signals generated upon recognition of specified events, conditions, and/or states.

Jumpstarting a Program Day Schedule

There are days when Program Members may wish to start the day early, thereby extending the hours during which that day's Communication Events/Program Markers will be distributed and sent or displayed to them, by moving the time of the first scheduled Communication Event/Program Marker of the day's Program Day Schedule to an earlier time.

The systems and methodologies of the present invention provide the means to change the Wake/Start/Begin/First Communication Event/Program Marker Date/Times of a Program Member's remaining Program Day Schedules by moving them forward or backward in time. All of the remaining Wake/Start/Begin/First Communication Event/Program Marker Date/Times for a Program can be set to a new different time by changing the Wake/Start/Begin/First Communication Event/Program Marker Date/Time variable in the Program Member's Program Record. Individual Wake/Start/Begin/First Communication Event/Program Marker Date/Times for a particular day's Program Day Schedule can be moved forward in time through requests in the form of Jumpstart Program Input Codes.

In the present invention, a system and methodology is provided by which Jumpstarting a Program Day Schedule can be requested by Program members, others, or automatically by means of signals generated upon recognition of specified events, conditions, and/or states.

Excluding a Period of Time in a Program Day Schedule

There are days when Program Members may wish to block or otherwise exclude interaction with the Program throughout a specified period of time during which previously tentatively scheduled Communication Events/Program Markers are not being sent or displayed to the Program Member.

The systems and methodologies of the present invention provide the means to exclude in whole or in part any or all interactions and communications between the Program Service and the Program Member, and/or others associated with the Program Member's Program during a specified period of time intersecting with the Program Member's Program Day Schedule(s). All of the remaining Communication Events/Program Markers tentatively scheduled in the rest of the Program Day are automatically redistributed with tentatively calculated and scheduled Date/Times within the remaining portion(s) of time before and/or after the Exclusion Period. Exclusion Periods can be specified and requested through the use of Program Input Codes.

In the present invention, a system and methodology is provided by which Excluding a Period of Time from a Program Day Schedule can be requested by Program members, others, or automatically by means of signals generated upon recognition of specified events, conditions, and/or states.

Flagging and Use of Flags to Reconfigure Programs and Program Day Schedule Profiles

There is significant utility in providing the means for Program Members, others, and/or automated processes to Flag points or segments of time within Programs and/or Program Day Schedules and associate meanings, values and/or link things with those Flags. The systems and methodologies of the present invention provide the means to Flag and/or otherwise mark or designate a point or segment of time within a Program and/or Program Day Schedule and specify and associate meanings and/or values and/or link associated and/or non-associated things to said Flagged point or segment of time. Flags can be chosen, specified, and inserted into a Program Member's Program Record through the use of Flag Program Input Codes.

In the present invention, a system and methodology is provided by which Flags of specified types and optionally associated values and/or linked things can be inserted into a Program Member's Program Record by Program members, others, or automatically by means of signals generated upon recognition of specified events, conditions, and/or states.

Furthermore, in the present invention, a system and methodology is provided by which Flags can be used individually, in groups, or accumulatively as input into Program Flag associated functions that at predetermined events, points, or states related to Flag Program Input codes will in return initiate a process resulting in a change to the Program Member's Program and/or Program Profile, including, but not limited to Program and/or Program Day Schedule Profile changes, actions, services, communications, or information events.

Banking and Withdrawal of Banked Communication Events/Program Markers During a Program Day Schedule

Despite the extent to which the shaping and redistribution functions of the present invention can support the customized and/or individualized fitting of and subsequent dynamic reconfiguration of Program and/or Program Day Schedule Profiles to a Program Member's or participant's often irregular life schedule, there is significant utility in providing a way for certain Communication Events/Program Markers to be set aside so that they can be requested by the Program Member, others, or automatically by means of signals generated upon recognition of specified events, conditions, and/or states. This setting aside of Communication Events/Program Markers within a Program Day Schedule is provided by the present invention through the method of Banking and the subsequent requested retrieval of Banked Communication Events/Program Markers, which is enabled by the present invention through the system and method of Withdrawal.

Banking of a certain number or percentage of Communication Events/Program Markers in a Program Member's Program Day Schedule can be specified and enabled as part of a Program's ongoing Program Profile and Program Day Schedule Profiles, or can be specified on an irregular basis via Program Input Codes or equivalent means by Program Members, others, or automatically by means of signals generated upon recognition of specified events, conditions, and/or states.

Withdrawal of Banked Communication Events/Program Markers in a Program Day Schedule can be made at any time between the Wake/Start/Begin/First Communication Event/Program Marker Date/Time of a currently active Program Day and the Wake/Start/Begin/First Communication Event/Program Marker Date/Time of the following day. Status on the number of remaining Banked Communication Events/Program Markers can be obtained along with other up-to-date Program and Program Day Schedule statistics through the Request Status Program Input Code or equivalent means of request.

In the present invention, a system and methodology is provided by which a certain number or percentage of Communication Events/Program Markers allotted within a particular Program Day Schedule can be set aside or Banked, and a corresponding system and methodology by which these said Banked Communication Events/Program Markers can be retrieved or Withdrawn by Program members, others, or automatically by means of signals generated upon recognition of specified events, conditions, and/or states.

Backsetting and Forwardsetting Within a Program and the Associated Recalculation and/or Rescheduling of the Daily Allotment of Program Communication Events/Program Markers and Respectively Associated Adjustments to Program's Calendar Schedule and Profile

It is important and valuable for a behavioral modification program, and particularly in those programs that are focused on increasing or decreasing some particular behavior, to have the means to reset a Program Member's or participant's current associated behavioral prompting parameters within a Program. In increasing or decreasing programs, this is equivalent to moving the Program Member ahead or back.

The reasons for needing such a function may vary widely, from simply being mismatched to the Program Member's or participant's current ability to comply, or because perhaps the Program Member began to cheat on compliance, and over some period of time become significantly unsynchronized or uncoordinated with the current specified behavioral compliance regimen. For example, the current behavioral prompting profile may be or have become too difficult, or conversely too easy. In the former, it may be necessary to Backset the Program Member to an earlier, and hence more comfortable or appropriate level of behavioral compliance. In the latter, a Program Member who feels that he or she could move forward to an advanced or possibly more challenging level of behavioral compliance.

Backsetting and Forwardsetting provide the means in the present invention for moving backward or forward respectively within a Program. Such functions may also be useful in programs that are not simple increase or decrease programs, but for which there may be a need to move a Program Member backward to an earlier stage, phase, or level or forward to an advanced stage, phase, or level. In the example of a smoking cessation program, Backsetting involves setting the daily allotment of Communication Events/Program Markers to a higher number, which corresponds to an earlier point in the Program. Conversely, Forwardsetting in the same type of Program involves setting the daily allotment of Communication Events/Program Markers to a lower number, which corresponds to an advanced, future point in the Program.

Program Member Information and Program Record in a Behavioral Modification and/or Maintenance Program Service

The present invention includes the means to register Program Members, record their personal identification, payment transaction information, demographic, psychographic, and sociographic information, and track their Program-related behavior and information during an active behavioral modification and/or maintenance program. Program Member records are divided into two primary portions. The first portion includes, but is not limited to, the Program Member's Personal Identity, Contact and/or Address Information, and optionally Payment Transactional Information. It may also contain a Program Member-chosen or participant-chosen username or Program Pseudonym.

Optional Payment Transaction information, such as a credit card number, may be used temporarily by the Program System to handle payment, and as such may or may not be permanently retained as part of the Program Member's or participant's record.

The second portion of Program Member records, also referred to as the Anonymized Program Member and Program Information, which is divided into the following subsections: Primary or Required Program Member Information, Primary Behavioral, Personal, Behavioral, Social, Situational, Contextual, and Demographic Information, Secondary Program Member Information, Primary Behavioral, Personal, Behavioral, Social, Situational, Contextual, and Demographic Information, Other Information and/or Input, and the Program and Performance Record. Primary or Required Program Member Information preferably includes, but is not limited to, ZIP or postal code, gender, and age.

Primary Behavioral, Personal, Behavioral, Social, Situational, Contextual, and Demographic Information includes, but is not limited to, the period of time associated with the program-related behavior, current program-related behavioral patterns, history and information on past attempts to modify behavior, current major life events and issues, description of family and social support structures, etc.

Secondary Behavioral, Personal, Behavioral, Social, Situational, Contextual, and Demographic Information includes, but is not limited to, marital status, income and other socioeconomic information, admired or trusted figures or sources, history with behavior modification programs for behaviors other than that associated with the program, attitudes, values, choices, affiliations, complaints, etc.

Other Information and/or Input includes, but is not limited to, information, states, conditions, histories, current events, personal, family, work, and/or social states, status, or situations that might be germane to understanding the whole context of the Program Member, in order to better understand how the Program successfully or unsuccessfully matches the needs of different individuals in terms of efficiency, efficacy, ease, and/or other qualities that can be identified, compared, contrasted, measured, and/or rated.

The Program and Performance Record includes, but is not limited to, the initially-configured or chosen Program Profile and Program Day Schedule Profile, Current Program Profile at point during the Active Program, Ultimate success or failure of the Program, and a detailed history and/or charitable data representing all Date/Time-stamped Program Events and Program Member actions, requests, and other informational inputs during the Active Program.

### BRIEF DESCRIPTION OF THE DRAWINGS

FIG. 1 depicts a block diagram overview of the primary operation of the system and method herein disclosed and described.

FIG. 2 depicts the ability of the disclosed system and method may operate as a stand-alone device or application or in communication with a remote Program Service over a network from initial registration to development of a customized Behavioral and/or Maintenance Program which is dynamically reconfigurable over the course of the Program based on user actions and responses.

FIG. 3 depicts the system and methodology by which the software or Computer Program is employed to assimilate daily tentative event allocations and associated tentative program day schedules for program markers for projected 30 day program.

FIG. 4 depicts a representative overview of a day in the program. This drawing describes how intervals between Communication Events/Program Markers are calculated in a dynamic, ongoing manner based on receipt of acknowledgment feedback from the User or Program Member subsequent to a Communication Event/Program Markers (communicated or displayed by the service to the Program Member). It describes how regular intervals are assumed at the beginning of the day, and how if any tentative calculated interval subsequent to a Communication Event/Program Marker is exceeded without receiving receipt and/or compliance feedback from the Program Member, the next Communication Event/Program Marker is scheduled and remaining intervals are re-alloted to the remaining time in the Program Day. Furthermore, the drawing shows how random time periods centered around (before and after) calculated Communication Event/Program Marker points may, optionally be introduced into the calculations the service's computer program uses to determine the active scheduling times, resulting in somewhat random point at which Communication Events/Program Markers are actively scheduled.

FIG. 5 depicts the computer program and rescheduler algorithm and employment thereof for initial tentative allotment of events at tentative intervals during an active program day schedule and the ability to revise the remaining allotment and intervals of events to new tentative intervals of the remaining program day schedule based on each user response over the program day schedule.

FIG. 6 depicts a portion of the Computer Program that manages the communication and sending or displaying of Communication Events/Program Markers.

FIG. 7 depicts the shaping of program files depending on user requirements, initial user input, or external forces.

FIG. 8 shows the shaping of profiles which can be shaped in a wide variety of profiles to benefit Program Members.

FIG. 9 depicts a plateau function of the program providing means to suspend daily progress and maintain the allotment of events at a substantially constant level for one or a plurality of program days.

FIG. 10 shows the insertion of an exemplar three day plateau in and eighty day user or subscribers program profile.

FIG. 11 depicts a redistribution of events and program markers in a program day schedule providing a front-loading of compressed event intervals.

FIG. 12 shows a function of the program wherein time is added to a program day schedule based on inputs thereto and requisite re allotment of events to accommodate the expanded day schedule.

FIG. 13 depicts the addition of time to a Program Day Schedule is based in a calculation the total time between a Program Day Schedule extension request and the scheduled last communication event or program marker for the day and the re allotment of events over the duration of the expanded remaining time.

FIG. 14 depicts a delete time function adapted to subtract time from a program day schedule.

FIG. 15 shows the deletion of time from a program day schedule through a calculation of the total time between the time of the Program Day Schedule shortening request and the scheduled Sleep/Last Communication Event/Program Marker and the resulting re allotment of events over the duration of the resulting compression of remaining time.

FIG. 16 shows the provision of a means for a Program Member or Associate to Jumpstart a Program Day Schedule to an earlier start hour moving forward from the original scheduled starting time.

FIG. 17 depicts the jumpstarting of a Program Day Schedule which is determined by calculating the total time between the time of the Jumpstart request and the scheduled Sleep/Last Communication Event/Program Marker and the resulting tentative reallocation of events over the new time duration.

FIG. 18 depicts the provided Exclude function which provides a means for a Program Member or, optionally, a Program Associate, to exclude or block a segment of time within or partially overlapping the Active portion of a Program Day Schedule.

FIG. 19 shows the re allotment of events initiated by the exclude function during a Program Day Schedule which is accomplished by first determining the total amount of communication events/program markers would have been scheduled for the excluded time segment.

FIG. 20 depicts the provision of a means for a Program Member or, optionally, a Program Associate, to enter into the Program Member's Program Record Flags which allow for commenting and identify events, states, or other flagged events.

FIG. 21 shows the use of flagging by members, coaches or guides which may also be subsequently used by the Program Server to reshape the Program and/or Program Day Schedule.

FIG. 22 shows a function of the method herein where a certain number of Communication Events/Program Markers may be set aside, or Banked, so that these can be requested, or Withdrawn, by the Program Member.

FIG. 23 depicts the option to have some of the Program Member's to Communication Events/Program Markers banked or set aside for the current Program Day Schedule.

FIG. 24 depicts a provided means for a Program Member or a Program Associate to reset a Program Member's or participant's current associated behavioral prompting parameters within a Program, through the Backsetting and Forwardsetting functions.

FIG. 25 depicts the Backsetting and Forwardsetting which allows a Program Member's current position within a Program Member's Program Profile and Schedule to be moved backward or forward respectively.

FIG. 26 shows the included means to register Program Members, record their personal identification, payment transaction information, demographic, psychographic, and sociographic information, and track their Program-related behavior and information during an active behavioral modification and/or maintenance program and the ability to divide Program Member Information and Program Records into Personal Identification and Anonymized portions

FIG. 27 depicts storage of the complete Master Program Member Program in the Program Service Database and therein accessible by the Program Member or other authorized individuals.

### DETAILED DESCRIPTION OF THE PREFERRED EMBODIMENTS

For purposes of describing the present invention in sufficient detail and in a real application, the embodiment of a program for behavior modification as employed for smoking cessation will be used as an example here. Of course those skilled in the art will realize that the system can be employed for alteration of other human behaviors and any such employment as would occur to those skilled in the art is anticipated to be within the scope of this patent. It is typical of behavioral modification programs where an activity is progressively and incrementally decreased over the time period of the program, beginning with the current number of cigarettes smoked per day and ending with zero cigarettes smoked per day.

Programs that maintain or vary in communication intervals, such as behavioral maintenance or coaching programs would be similar, but Communication Events/Program Markers would not necessarily decrease over time. Likewise, programs where the goal was to increase particular behaviors might have Communication Events/Program Markers increasing during the program period.

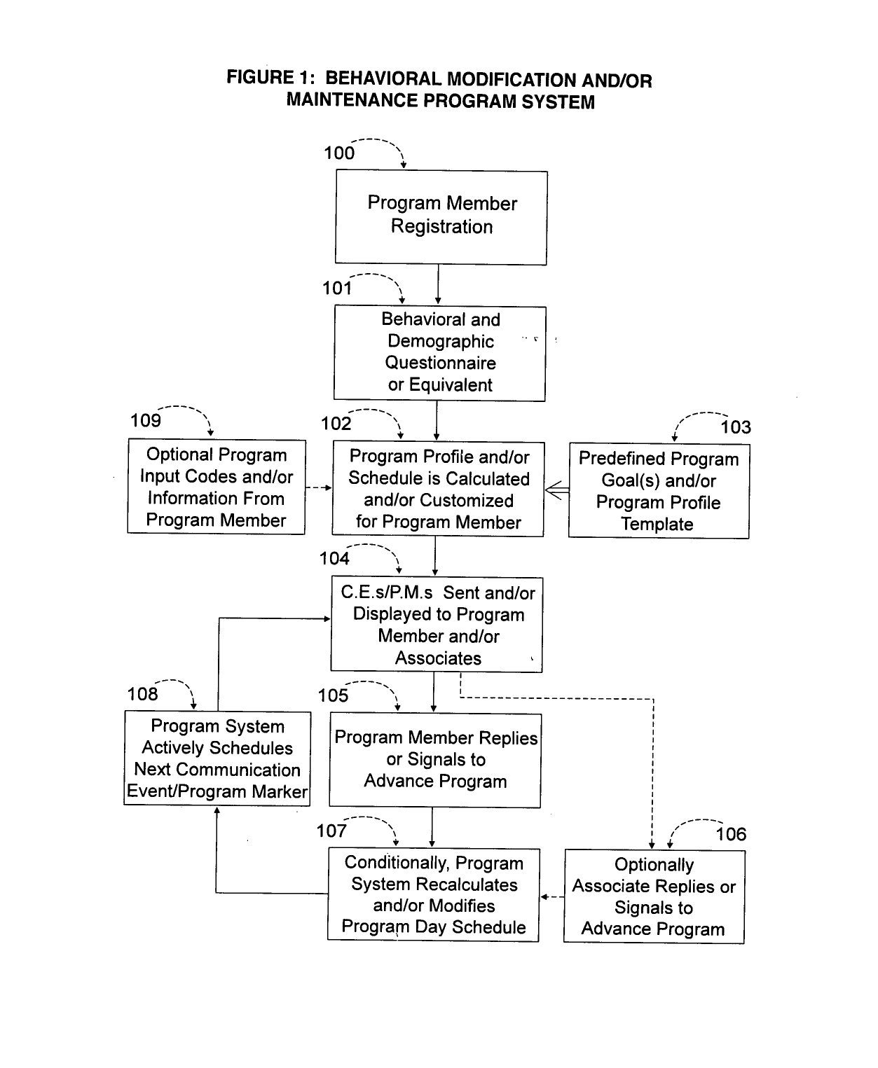

FIG. 1—The present invention supports and provides the means for establishing, customizing, managing, and dynamically reconfiguring a Behavioral Modification and/or Maintenance Program System (FIG. 1).

To initiate and begin the Behavioral Modification and/or Maintenance Program, the prospective Program Member and/or other Program Associates acting on his or her behalf, enter into a Registration and/or Initialization Process (100), establishing Initial Program Registration and/or Initial Program Application/Device Initialization and Program Commencement. Means to input registration data during the Registration Process may include, but is not limited to, using a form, providing in the first section Personal Identification Information, including, but not limited to, name, communication contact Information, address, and optionally information necessary to support payment transactions. Furthermore, said Program Member may optionally choose a username or pseudonym for use in the Program Service. In a preferred mode of the system, the means for input of registration data is handled over a computer network where a host computer receives the input data from the user's remote input device such as a home or other computer.

Next, the Program Member, or someone or something acting on their behalf, employing a means to input data regarding behavior for modification, provides in the second section of the form (101), non-personally-identifiable information regarding program-related behavioral patterns, including, but not limited to current waking hours, behavior history, frequency, and/or other descriptions, attributes, or appropriate measurements. This behavior data can be communicated in fashion similar to the registration data above. Also provided in the second section of the form are answers to and information regarding the Program Member's or participant's demographics, psychographics, sociographics, and any other information that can provide distinguishing and/or comparative context between individual Program Members.

The Service System's computer program then assigns a Behavioral Modification and/or Maintenance Profile (102) to the Program Member's Record, which may involve a calculation of Program Calendar Length having a beginning and lasting for a term consisting of a plurality of sequential days, based on a rate of behavioral modification per day until a desired goal is reached, a behavioral maintenance program based on a fixed or indefinite period of time, or combinations of both. Furthermore, Program Profiles may be based on, or selected from predefined Program Goals and/or Program Profile Templates (103), representing generic rates of behavioral modification or levels of behavioral maintenance over time and/or towards a desired goal.

The present invention engages and supports behavioral modification and/or maintenance for a Program Member by communicating to, and/or displaying to the user, Communication Events or Program Markers (104), which act as scheduling cues. Optionally, Communication Events/Program Markers can be sent or also sent as copies to Program Associates, such as coaches, guides, counselors, or Program Administrators who may be working with or otherwise associated with a Program Member.

Communication Events/Program Markers can be signals, or can contain a message or other informational or media content. Each Program Day in a Program Member's Program is allotted a specific number of Communication Events/Program Markers. This Daily Allotment of Communication Events/Program Markers are Tentatively Scheduled, initially in equal time segments distributed throughout the Active Program Day Period and optionally in non-equal time segments, between the Program Day Start/Begin/Wake Date/Time and the Stop/End/Sleep Date/Time.

Each Program Day during the term begins with the Program Service sending or displaying the first Communication Event/Program Marker to the user and generally requiring the performance of an action or task by the user. Communication Events/Program Markers are only Actively Scheduled upon receipt by the Program Service System of a Program Member's or, optionally Program Associate's Reply or Acknowledgment Signal that they received the immediately preceding Communication Event/Program Marker, with the exception of the first Communication Event/Program Marker of the Program's first day, which is Actively Scheduled after the immediately preceding Program Day's Stop/End/Sleep Date/Time. The first Communication Event/Program Marker of the Program's first day is Actively Scheduled upon completion of the Registration Process.

Subsequent to the First Communication Event/Program Marker for a Program Day, each following single Communication Event/Program Marker of the Program Day's Allotment is only Actively Scheduled for Sending or Display, after the Program Member (105) or, optionally, Program Associate (106) replies or otherwise signals receipt following the immediately preceding received Communication Event/Program Marker, and that the task has been completed.

If the Program Member's or, optionally, the Program Associate's Reply or Acknowledgment Signal is received by the Program Service within the interval between the last sent or displayed Communication Event/Program Marker and the next Tentatively Scheduled Communication Event/Program Marker, then the next Communication Event/Program Marker is Actively Scheduled to be sent or displayed at the same Date/Time as was Tentatively Scheduled.

However, if the Reply or Acknowledgment Signal, signaling receipt and completion of the previous task, is not received within the interval between the last sent or displayed Communication Event/Program Marker and the next Tentatively Scheduled Communication Event/Program Marker, then the Program Service sends a Missed Reply/Acknowledgment message or signal to the Program Member and, optionally, Program Associate, and then halts until a Reply/Acknowledgment message or signal is received signaling completion. Or, if the Program Day's Stop/End/Sleep Date/Time is reached, the system moves to the next Program Day and Actively Schedules its first Communication Event/Program Marker (108).

If the Reply/Acknowledgment message or signal is received after the Date/Time of the next Tentatively Scheduled Communication Event/Program Marker, but before the Program Day's Stop/End/Sleep Date/Time is reached, the Program Service immediately sends the next Communication Event/Program Marker and redistributes the Active Program Day's remaining allotted Communication Events/Program Markers with shorter intervening time intervals (107).

Optionally, there may be a set minimum interval time between Communication Events/Program Markers, such that if a Program Member or, optionally, Program Associate Replies or Signals Acknowledgment too close to the Program Day's Stop/End/Sleep Date/Time, the Program Member may effectively lose some of the Program Day's Communication Events/Program Markers. However the present invention has the means to allow requests extensions to the Active Program Day Period, which could be used in such situations.

Additionally, and separate from the back and forth activities involving Communication Events/Program Markers and following associated Replies or Acknowledgment Signals, at any time during an Active Program Calendar Period, the Program Member or Program Associate may, optionally, send and/or otherwise signal information to the Program Service in the form of Program Input Codes or equivalent means. These can represent requests to alter or reconfigure the Program Profile or Program Day Schedule Profile, or contain information including, but not limited to, signals, comments, status reports, diary entries, or other Program Record Flags. These Signals or Information are received by the Program Service, Date/Time-stamped, and entered into the Program Member's Program Record. If appropriate, associated requested actions, alterations, or reconfiguration to the Program Member's Program are then executed by the Program Service and a Reply or Acknowledgment Signal is sent or displayed to the Program Member and, optionally, Program Associate.

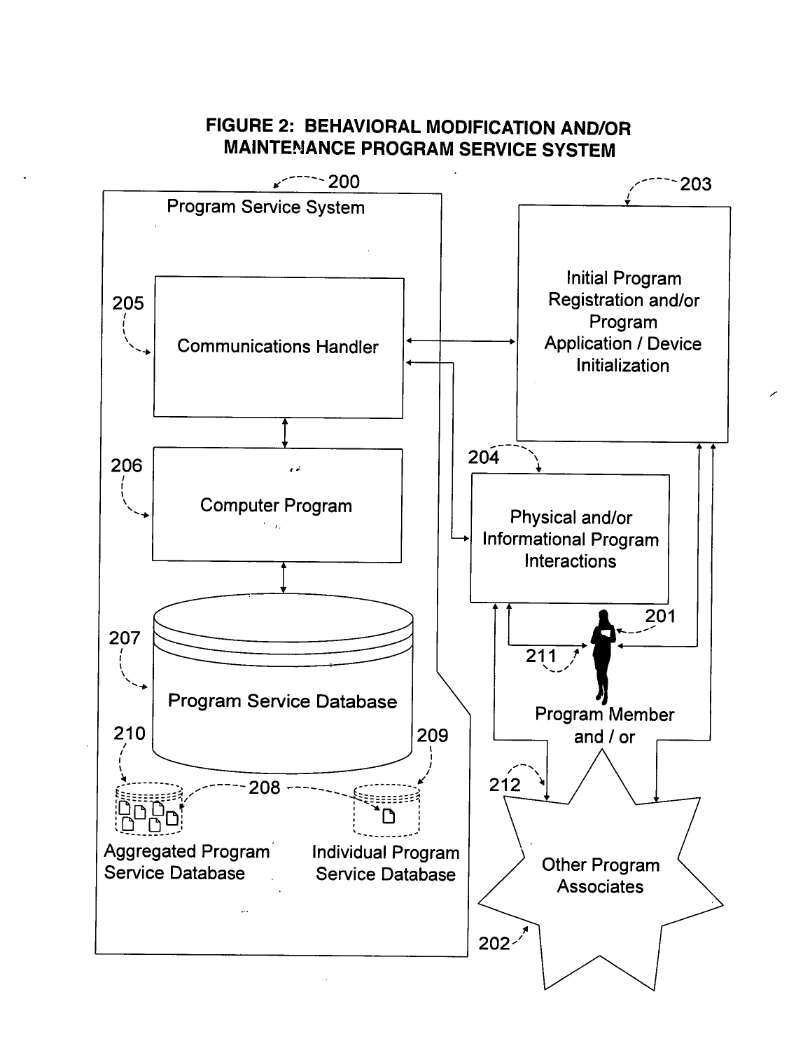

As can be seen in FIG. 2 the present invention is a Program Service System (200), and may be embodied as a standalone device or application, or a device or application that communicates with external Program Service System Components, or as a centralized Program Service that coordinates with devices such as, but not limited to, telephones, pagers, or client applications.

The Program Service System supports a Program that guides and supports a Program Member (201) in an effort to modify and/or maintain behavior. Program Members may, optionally, be supported, or guided during their term of participation in the Program by Program Associates (202), examples of which may include, but are not limited to, Coaches, guides, external parties or systems, or conditional signals), which like the Program Member, can provide registration, information input, feedback, flags and markers, ratings, and other additional input independent of scheduled program communication events. Such input may be used for informational or data gathering purposes and/or may be used to dynamically alter or reconfigure the Program Profile or Program Day Schedule Profile.

To initiate and begin a Behavioral Modification and/or Maintenance Program, the prospective Program Member and/or other Program Associates acting on his or her behalf, enter into a Registration and/or Initialization Process (203), establishing Initial Program Registration and/or Initial Program Application/Device Initialization and Program Commencement. The Registration Process may include, but is not limited to, using a form, providing in the first section Personal Identification Information, including, but not limited to, name, communication contact Information, address, and optionally information necessary to support payment transactions. Furthermore, said Program Member may optionally choose a username or pseudonym for use in the Program Service.

Next, the Program Member, or someone or something acting on their behalf, provides in the second section of the form, non-personally-identifiable information regarding program-related behavioral patterns, including, but not limited to history, frequency, and/or other descriptions, attributes, or appropriate measurements. Also provided in the second section of the form are answers to and information regarding the Program Member's or participant's demographics, psychographics, sociographics, and any other information that can provide distinguishing and/or comparative context between individual Program Members.

The Program Service System's computer program then assigns a Behavioral Modification and/or Maintenance Profile to the Program Member's Record, which may involve a calculation of the term of the Program Calendar Length based on a rate of behavioral modification per day until a desired goal is reached, a behavioral maintenance program based on a fixed or indefinite period of time, or combinations of both. Furthermore, Program Profiles and their ultimate term, may be based on, or selected from predefined Program Goals and/or Program Profile Templates, representing generic rates of behavioral modification or levels of behavioral maintenance over time and/or towards a desired goal.

Upon completion of Initial Program Registration and/or Initial Program Application/Device Initialization, the Program Member's Program commences and supports Program Interactions (204) between the Program Member and, optionally, Program Associates, and the Program Service System.

Program Interactions include, but are not limited to, Communication Event/Program Marker Replies or other Feedback, Program Input Codes that provide data and/or can be used to alter a Program Schedule and/or Program Day Schedule, or request a Program Feature or Function. Program Interactions are facilitated by the Communications Handler (205), which is part of the Program Service System and comprised of the means to send (211) (212) to and receive from Program Member and/or Program Associates, Communication Events/Program Markers, consisting of Commands, Permissions, Suggestions, Encouragement, Guidance, Allowances, Markers, Reports, Measurements, Program Input Codes or Signals, etc.

The Communications Handler facilitates communication between the Program Service System's Computer Program (206) and Program Member in order to facilitate dynamic adjustment of Program Member's Behavioral Modification and/or Maintenance Program. The Program Service System's Computer Program consists of the Registration Mechanism (or New Program Member Information Entry Mechanism in an application), Communication Event/Program Marker Allotment Calculation Algorithm, Communication Event/Program Marker Calculation and Scheduling Algorithm, Program Service Database Query Mechanism, Program Member Record Manipulation, and Chart Producing Mechanisms.

The Program Computer Program works with both the Communications Handler and the Program Service Database (207). The Program Service Database contains and organizes Program data, including, but not limited to, Profile Templates, Program Member Behavioral/Maintenance Program Profiles and Schedules, Program Member Personal Identification Information, Program Member Behavioral information, Program Member Demographic, Psychographic, and Sociographic information, Program Daily Communication Event/Program Marker Allotment Schedules, and Tentatively Scheduled and Actively Scheduled Program Day Intervals between Communication Events/Program Markers, and Program Member Program Records.

Program Member Records (208) may be stored in multiple embodiments. Program Member Records may be stored in an Aggregated Program Service Database (210), which is one that contains the Program Records of more than one Program Member, and may, optionally, be implemented and/or work over a network. Program Member Records may also be stored in an Individual Program Service Database (209) which may or may not share data and/or control with external Program Service System Components.

Program Member Records may also be stored in multiple forms and places, such as a single Program Member client Program Service Database that exists partly or wholly on a device and/or software application, and which periodically synchronizes with another instantiation of the same Program Member's Program Record in an Aggregated, multi-Program Member Program Service Database.

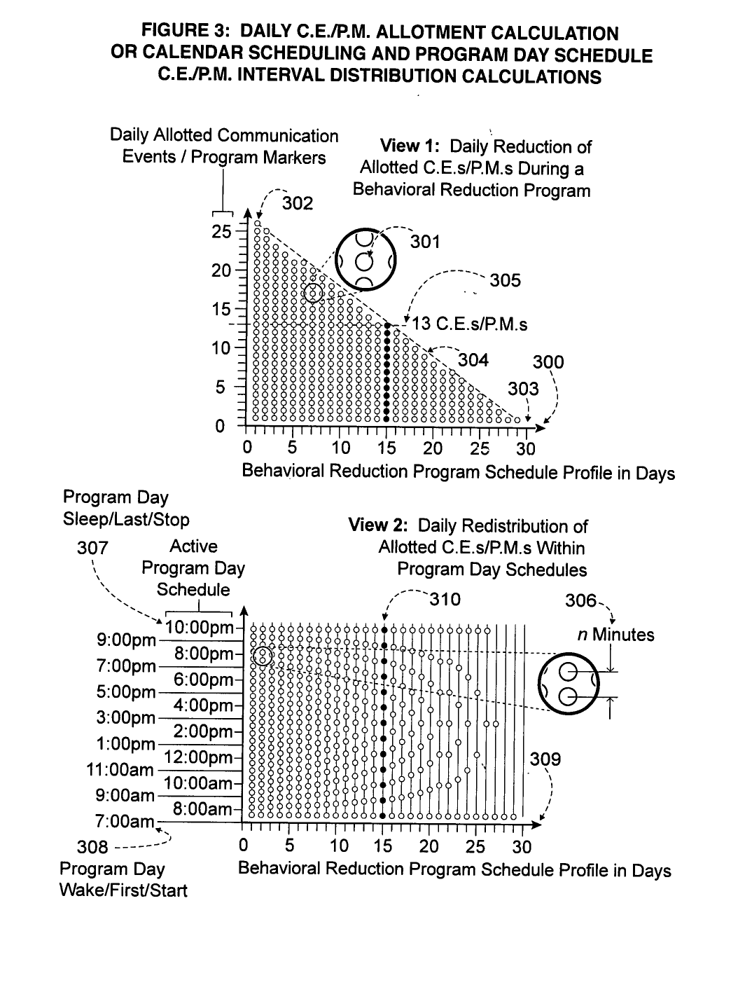

Depicted in FIG. 3 in the present invention a behavioral modification and/or maintenance program is comprised of term of Program Days, each of which is assigned a Daily Allotment of Communication Events/Program Markers. Using the example of a Program Member with a goal to reduce a behavior such as the smoking of cigarettes from 26 per day to 0 per day, in a 30 day behavioral reduction Program Schedule (300), the total starting daily allotment of Communication Events/Program Markers (301) to be distributed throughout the Program Day Schedule (behavioral/maintenance units or focus) begins with 26 Communication Events/Program Markers (302) and ends with 0 Communication Events/Program Markers (403). The line representing the changing daily allotment of Communication Events/Program Markers per day, from day to day throughout a program, is the Program Profile (304).

The simplest form of Program Profile for a reduction-oriented program would be a straight diagonal run/fall slope. The calculation to derive the total Communication Event/Program Markers for a given day, for example day 15, is:
(15/30)×26=13 Communication Events/Program Markers. (305).

Such a tentatively scheduled Daily Allotment of Communication Events/Program Markers may be dynamically altered during an Active Program Calendar Period if the Program Member or, optionally, Program Associates request changes, such as, but not limited to, Profile Shaping functions, Program Extensions, Plateaus, Backsetting or Forwardsetting changes, etc.

Using the same example, for any given Program Day, the daily Tentatively Calculated interval (in minutes) (306) between Communication Events/Program Markers=Total minutes of (Sleep/Last/Stop Time (307) minus the Wake/First/Start Time (308) for a day), divided by quantity/amount of Communication Events/Program Markers allotted for that day, according to the Program Daily Communication Event/Program Marker Allotment Schedule (309).

Total time between Wake/First/Start to Sleep/Last/Stop=900 minutes. The calculation to derive the total Communication Event/Program Markers for a given day, for example day 15, is:
(15/30)×26=13 Communication Events/Program Markers. (305)

Calculated tentative interval between scheduled Communication Events/Program Markers at start of day 15 is=A/B=69.2 minutes (310).

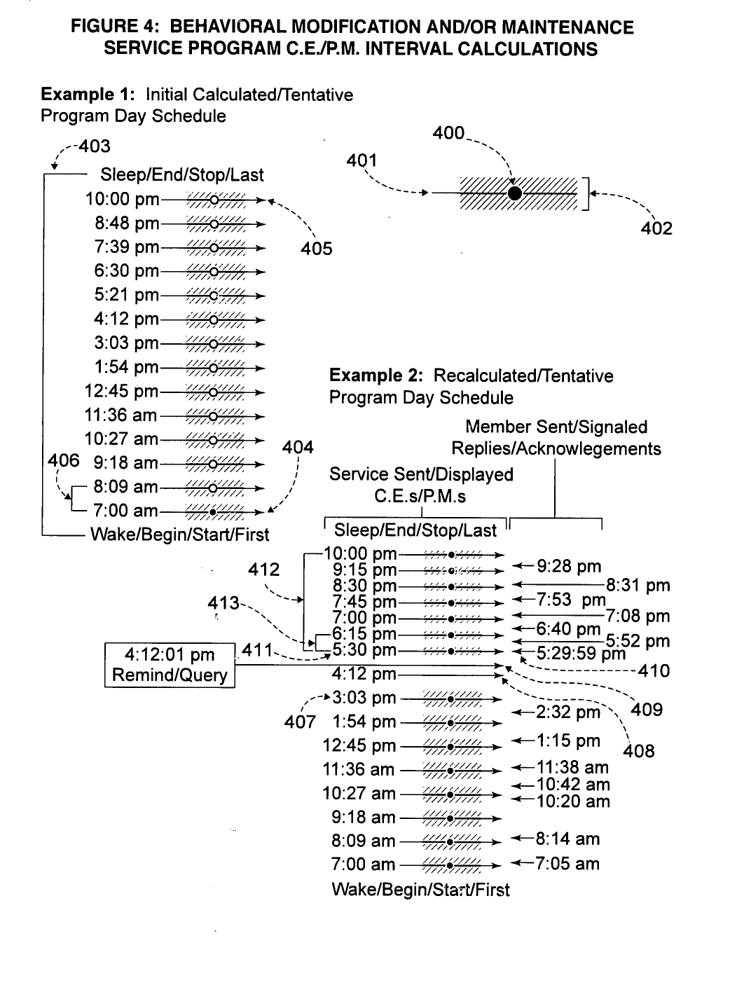

As shown in FIG. 4, for any given Program Day within an Active Program, the present invention distributes that Program Day's allotted Communication Events/Program Markers between the Wake/Begin/Start/First Date/Time and the Sleep/End/Stop/Last Date/Time.

Each Program Day during the term begins with the Program Service sending or displaying the first Communication Event/Program Marker. Communication Events/Program Markers are only Actively Scheduled upon receipt by the Program Service System of a Program Member's or, optionally Program Associate's Reply or Acknowledgment Signal that they received the immediately preceding Communication Event/Program Marker, with the exception of the first Communication Event/Program Marker of the Program's first day, which is Actively Scheduled after the immediately preceding Program Day's Stop/End/Sleep Date/Time. The first Communication Event/Program Marker of the Program's first day is Actively Scheduled upon completion of the Registration Process.

Subsequent to the First Communication Event/Program Marker for a Program Day, each following single Communication Event/Program Marker of the Program Day's Allotment is only Actively Scheduled for Sending or Display after the Program Member or, optionally, Program Associate replies or otherwise signals receipt following the immediately preceding received Communication Event/Program Marker.

Using a similar example of program having a Day 15 of a 30 day term for behavioral reduction-oriented program beginning with 28 behavioral instances and reducing to 0 behavioral instances, the starting day's allotment of Communication Events/Program Markers (400) in day 1's Program Day Schedule (behavioral/maintenance focus) was 28 units (Communication Events/Program Markers). In this example, at day 15, the calculation, or specified schedule, of Communication Events/Program Markers for day 15's Program Day Schedule (403) is 14 units.

Wake/Begin/Start/First Communication Event/Program Marker is set in the Program Member's record as 7:00 am (404). Sleep/Stop/End/Last Communication Event/Program Marker is set in the Program Member's record as at 10:00 pm (405). Initial Calculated/Tentative Interval between scheduled Communication Events/Program Markers is 69 minutes (406). Calculated/Tentative Date/Times to send or display Communication Events/Program Markers (401) are 69 minutes apart. Actual Communication Event/Program Marker send/display time may, optionally, be adjusted over a small random time spread (402). This adjustment calculation may, optionally, further be based on a percentage of time between current calculated intervals.

Recalculation of Tentatively Scheduled Communication Events/Program Markers occurs when a Program Member or, optionally, Program Associate sends a reply and/or signals an acknowledgment beyond the Program Service System's currently Tentatively Scheduled Interval Time. Using the same example as above, a reply/acknowledgment following the Communication Event/Program Marker sent to the Program Member at 3:03 pm (407) was not received within the expected interval ending at 4:12 pm (408), when the next tentatively scheduled C.E./P.M was to be sent, so at 4:12:01 pm a Reminder (409) was sent to the Program Member indicating no Reply/Acknowledgment had been received and the Program will not continue until one is.

Program Member reply to a sent Communication Event/Program Marker is subsequently received at 5:29:59 pm (410) by the Communications Handler, and the Program Service responds immediately by sending the delayed Communication Event/Program Marker at 5:30 pm (411). Thereafter, remaining allotted intervals for Communication Events/Program Markers in the Program Day Schedule (between 5:30 pm and 10:00 pm) are recalculated by dividing the time remaining in the current active Program Day Schedule by the number of remaining allotted Communication Events/Program Markers (412).

In this example, the newly Recalculated/Tentative intervals between Communication Events/Program Markers are shortened to 45 minutes each (413), to which the Program Member is shown to reply/acknowledge within the calculated time intervals.

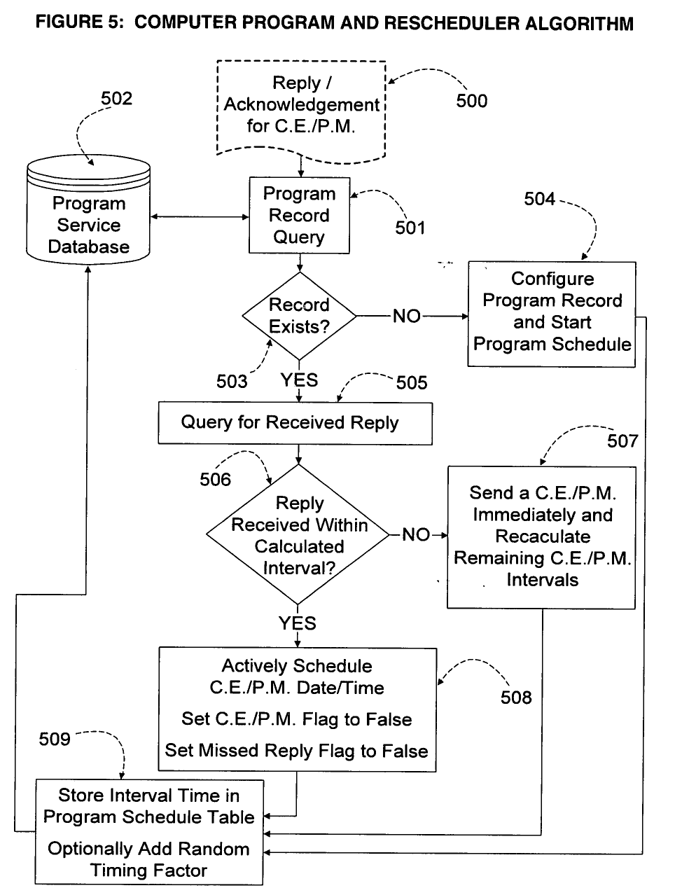

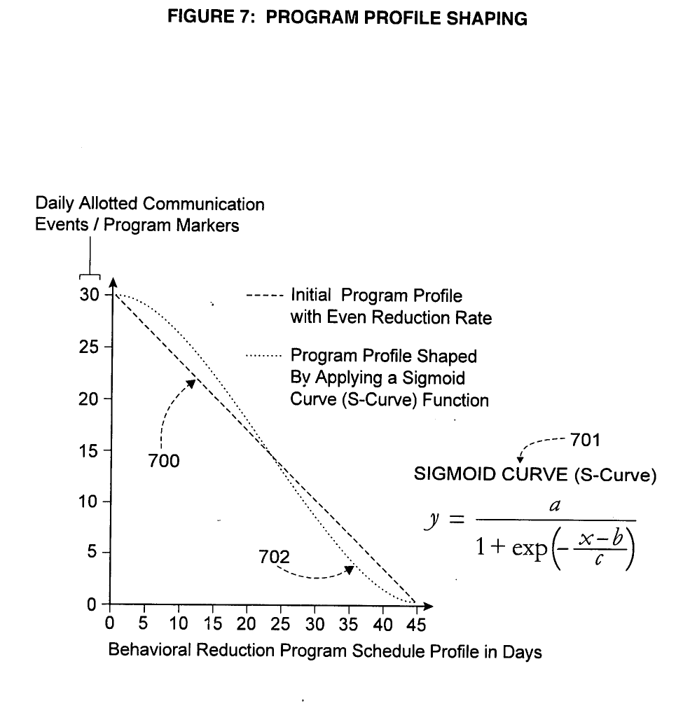

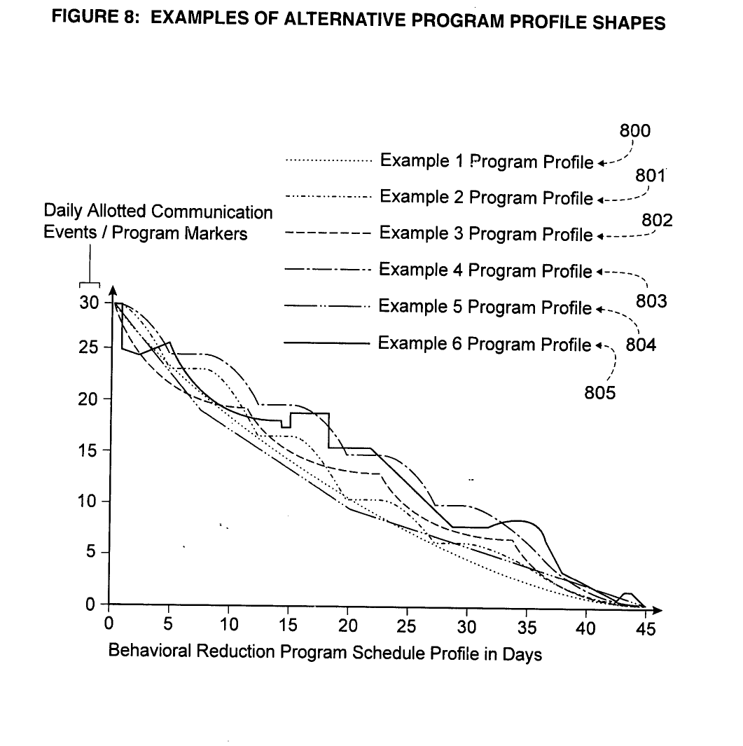

In FIG. 5 is shown typical program Interactions between the Program Service System and Program Member and, optionally, Program Associates are managed by the Program Service System's Computer Program. The Program Service System's Computer Program handles Tentative and Active Scheduling of Communication Events/Program Markers with any given Program Day by starting with a particular day's Daily Allotment of Communication Events/Program Markers. Daily Allotments are associated with the Program Profile, as described in FIG. 7 and FIG. 8. The Program Service System's Computer Program manages Program Interactions with the Program Member and, optionally, Program Associates in a method described in FIG. 5.

The Program Service System's Computer Program receives a reply or acknowledgment signal for a Communication Event/Program Marker previously sent or displayed to the Program Member (or someone else, such as a coach, counselor, administrator, system component, signal, state, or condition acting on behalf of the Program Member), or a new registration of a Program Member has occurred (500). The Computer Program queries (501) the Program Service Database (502) to determine if any matching Program Member Program Record exists yet.

The Program Service Database contains a multiplicity of tables. The first table referenced by FIG. 5, the Program Member Program Schedule Table, contains a multiplicity of fields, the following 7 of which are referenced: 1) Program Member Identification and Contact Mechanism; 2) Program Member's Program Daily COMMUNICATION EVENT/PROGRAM MARKER Allotment Calculation and/or Schedule; 3) Date/Time of next scheduled COMMUNICATION EVENT/PROGRAM MARKER; 4) Date/Time of next scheduled (calculated/tentative) Communication Event/Program Marker; 5) Communication Event/Program Marker Sent flag; 6) Date/Time of sent (calculated/tentative) Communication Event/Program Marker; and 7) Date/Time of last COMMUNICATION EVENT/PROGRAM MARKER of the Program Member's Program Day Schedule, in the Program Member Program Schedule Table.

The second table referenced by FIG. 5, the Program Member Behavioral Parameters Table, contains a multiplicity of fields, the following 4 of which are referenced: 1) Starting number of Program Member Behavioral Events (example: number of cigarettes smoked daily); 2) Length of Behavioral Modification and/or Maintenance Program; 3) Begin/Start/Wake schedule for each day of the week; and 4) End/Stop/Sleep schedule for each day of the week. If no matching Program Member Program Record exists (503), the Computer Program recognizes that this is a newly registered Program Member (504).

The Computer Program queries the Program Member Behavioral Parameters Table to determine Start Date/Time of Behavioral and/or Maintenance Program based on a Program Profile and/or Program Day Schedule Profile and, optionally, a preferred Start Day. The Computer Program then creates a new Program Member Program Schedule Record in Program Service Database for this Program Member and Actively Schedules the first Communication Event/Program Marker. The Computer Program then, optionally, takes a percentage of the current Calculated/Tentative Interval time and adds or subtracts this amount of time from the Calculated/Tentative Interval time if a random adjustment to the Actively Scheduled Date/Time is desired. The Computer Program then stores the Calculated/tentative Interval time or, optionally, subsequently adjusted Calculated/tentative Interval time, to the Program Member's Program Schedule Table (509) in the Program Service Database. If a matching Program Member Program Record does exist (503), the Computer Program queries the Program Service Database to determine if a COMMUNICATION EVENT/PROGRAM MARKER Reply has been received before the calculated/tentative Date/Time of the next scheduled COMMUNICATION EVENT/PROGRAM MARKER (505).

If the Program Service System received the Reply or Acknowledgment Signal after the Tentatively Scheduled Interval at which the next Communication Event/Program Marker was to be sent (506), the Computer Program Actively Schedules one of the remaining Program Day's Allotted Communication Events/Program Markers at the current Date/Time and sends or displays it immediately (507).

The Computer Program then divides the difference between the current day's recorded Stop/End/Sleep Time and the Current Date/Time by the number of remaining Communication Events/Program Markers in the current active Program Day Schedule. The Computer Program then records this new Calculated/Tentative Interval in the Program Member's Program Schedule Table in the Program Service Database. The Computer Program then, optionally, takes a percentage of the current Calculated/Tentative Interval time and adds or subtracts this amount of time from the Calculated/Tentative Interval time if a random adjustment to the Actively Scheduled Date/Time is desired. The Computer Program then stores the Calculated/tentative Interval time or, optionally, subsequently adjusted Calculated/tentative Interval time, to the Program Member's Program Schedule Table (509) in the Program Service Database.

If the Program Service System received the Reply or Acknowledgment Signal before the end of the Tentatively Scheduled Interval at which the next Communication Event/Program Marker was to be sent (506), the Computer Program uses the Date/Time of the last sent Communication Event/Program Marker, and adds the Calculated/Tentative Interval time to derive the Date/Time at which to Actively Schedule the next Communication Event/Program Marker. The Computer Program then stores the new Actively Scheduled Communication Event/Program Marker Date/Time in the Program Member's Program Schedule Table (508).

The Computer Program then sets the [Communication Event/Program Marker Sent] flag in the Program Member's Program Schedule Table to FALSE. The Computer Program then sets the [Missed Reply/Acknowledgment Notification Sent] flag in the Program Member's Program Schedule Table to FALSE.

The Computer Program then, optionally, takes a percentage of the current Calculated/Tentative Interval time and adds or subtracts this amount of time from the Calculated/Tentative Interval time if a random adjustment to the Actively Scheduled Date/Time is desired. The Computer Program then stores the Calculated/tentative Interval time or, optionally, subsequently adjusted Calculated/tentative Interval time, to the Program Member's Program Schedule Table (509) in the Program Service Database.

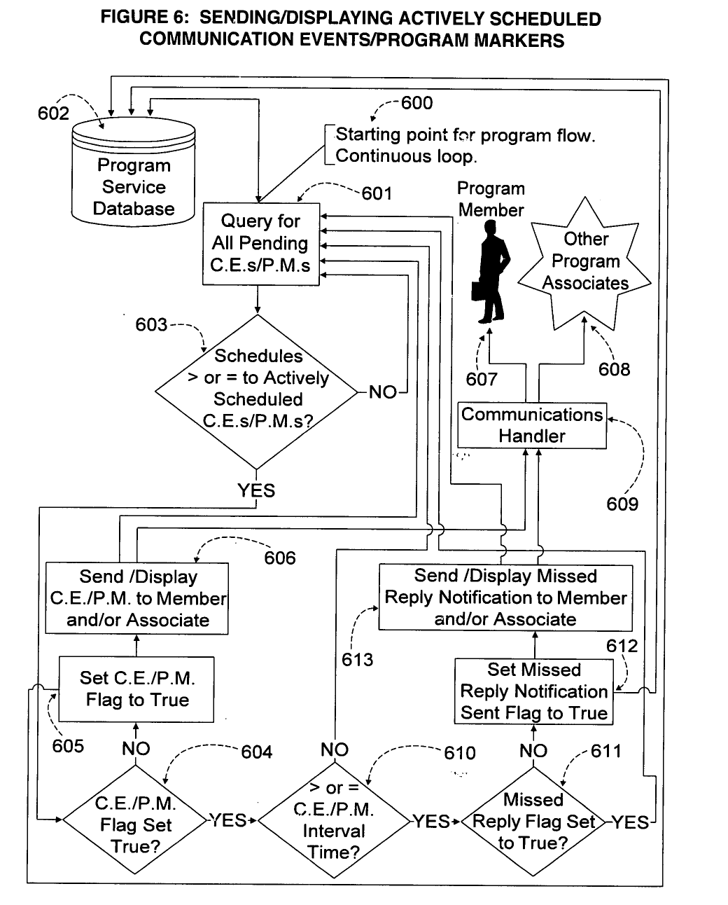

As depicted in FIG. 6 the portion of the Computer Program that manages the sending or displaying of Communication Events/Program Markers involves a continuous loop (600) that queries (601) the Program Member Program Day Schedule table in the Program Service Database (602) to retrieve a list of Program Members that have a Communication Event/Program Marker Tentatively Scheduled. The Program Service Database contains a multiplicity of tables.

The table referenced by FIG. 6, the Program Member Program Day Schedule Table, contains a multiplicity of fields, the following 7 of which are referenced:

1) Program Member Identification and Contact Mechanism;

2) Program Member's Program Daily COMMUNICATION EVENT/PROGRAM MARKER Allotment Calculation and/or Schedule;

3) Date/Time of next scheduled COMMUNICATION EVENT/PROGRAM MARKER;

4) Date/Time of next scheduled (calculated/tentative) Communication Event/Program Marker;

5) Communication Event/Program Marker Sent flag; 6) Date/Time of sent (calculated/tentative) Communication Event/Program Marker; and 7) Date/Time of last COMMUNICATION EVENT/PROGRAM MARKER of the Program Member's Program Day Schedule.

If the Date/Time of the Program Member's next Tentatively Scheduled Communication Event/Program Marker Is greater than the current Date/Time on the system the Computer Program is running (603), the Computer Program re-enters the continuous loop to continue processing (601.)

If the Date/Time of the Program Member's next Tentatively Scheduled Communication Event/Program Marker Is less than or equal to the current Date/Time of the Computer Program's system clock (603), and if the Communication Event/Program Marker Sent flag, in the Program Member Program Day Schedule Table, is not set to TRUE (604), the Communication Event/Program Marker Sent flag is set to TRUE (605), and a Communication Event/Program Marker is sent to the Program Member (607) through the Communications Handler (609) and, optionally, Program Associates (608), and the continuous loop is re-entered.

If the Communication Event/Program Marker Sent flag is set to TRUE (604) and if the Current Time of the Computer Program's system clock is not greater than or equal to the time of the next Tentatively Schedule Communication Event/Program Marker (610) then re-enter the continuous loop to continue processing (601).

If the Current Time of the Computer Program's system clock is greater than or equal to the time of the next Tentatively Scheduled Communication Event/Program Marker (610), and if the Missed Reply/Acknowledgement Notification Sent flag is not set to TRUE (611), then the Computer Program sets the Missed Reply/Acknowledgement Notification Sent flag to TRUE (612), and then sends a Notification of Missed Reply/Acknowledgement signal, through the Communications Handler (609), to the Program Member (613), and, optionally, Program Associate (608). The Computer Program then re-enters the continuous loop for additional processing (601).

If the Missed Reply/Acknowledgement Notification Sent flag is set to TRUE (611), the Computer Program re-enters the continuous loop for additional processing (601).

In FIG. 7 it is shown that the Program Profiles can be shaped in a variety of ways depending on program member requirements, input, or input by external forces such as coaches or other external input. A Program Profile Shaping involving a simple linear reduction, calculates the Daily Allotment of Communication Events/Program Markers by taking the total number of starting communication events and subtracting from it the value obtained by dividing the amount of days into the Program divided by the total number of days for the Program. This calculation reveals the number of Communication Events/Program Markers that will be scheduled on any given day into the Program.

### EXAMPLE 1

In a 45 day term Program with a starting value of 30 Communication Events/Program Markers and a simple linear reduction slope (700), the calculation of Communication Events/Program Markers scheduled for day 5 into the 45 day Program is as follows. 30−(5/45)=26.67 or (27 if rounding up).

By fitting a simple linear reduction slope to a Sigmoid Curve (S-Curve) (701), a custom profile can be obtained to shape the program member's program schedule (700). A standard calculation is done to find the coefficients of an S-Curve based on the standard input of the linear Program schedule data. The resulting coefficients that allow the linear Program Profile slope to best fit to an S-Curve is then used for future calculations of each program day's scheduled communication events.

### EXAMPLE 2

Based on the linear Program Profile slope presented above in example 1 (700), the S-Curve function (702) is y=a/(1.0+e(−(x−b)/c)). The calculated coefficients are:
a=3.2856001820150077E+01
b=2.1245793646688050E+01
c=−1.0332569172712693E+01

The calculation to determine the Communication Events/Program Markers scheduled for day 5 into the 45 day Program is as follows:
y=a/(1.0+e(−(5−b)/c))
y=27.2 or (27 if rounding)

Fitting target is lowest sum of squared (SSQ) absolute error (traditional). The result is a shaped Program Profile (702).

In FIG. 8 it is shown that Program Profiles can be shaped in a wide variety of profiles, if such profiles are found to provide benefit to the Program Members. The five examples above represent different Program Profiles, each varying from a basic straight linear slope. Example 1 (800) represents a Program Profile that's a simple curve with a steeper reduction of Communication Events/Program markers at the beginning of the Program and becoming less steep all the way to the end of the Program.

Example 2 (801) represents a Program Profile made up of successive cycles or series of curved segments, each of which begins with a gradual increasing of the steepness of the rate of reduction in Communication Events/Program Markers until it stops and the next gradual increase in the rate of reduction of Communication Events/Program Markers begins. Each such cycle would allow the Program Member to reduce behavior quickly, and then have time to adjust before gradually beginning another reduction cycle. This Program Profile also has an overall curved slope similar to Example 1 (800).

Example 3 (802) represents a Program Profile with slightly different successive cycles or series of curves that are similar to those in the Program Profile in Example 2 (801), but with each new cycle beginning with the steepest rate of reduction. This Program Profile also shares the overall curved slope with Examples 1 and 2.

Example 4 (803) represents a Program Profile that's very similar to the Program Profile in Example 2 (801), except with fewer and longer successive cycles from the beginning of the Program to the end, and with a straighter overall slope throughout the Program.

Example 5 (804) represents a Program Profile with three successive straight linear slopes. In such a Program Profile a Program In such a Program Profile, each successive straight linear segment would represent a lessening rate of reduction from day to day.

Example 6 (805) represents a Program Profile that's non-regular, and created manually in part or in whole, either by human definition, arbitrarily, or through the single or accumulative results of complex calculations.

The possibilities of Program Profile shaping are endless, though not all Program Profiles may yield Program or Program Member benefits.

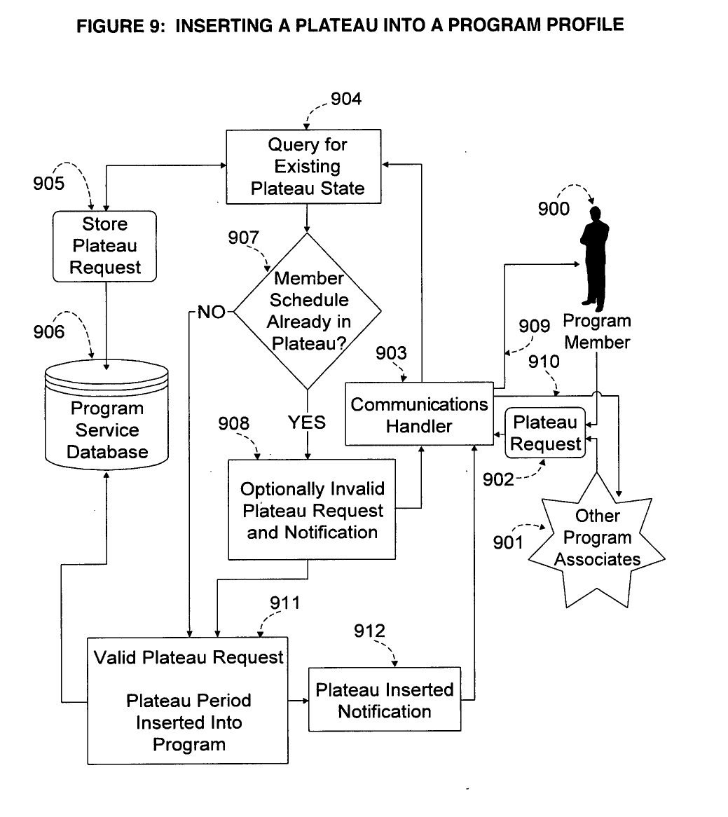

In FIG. 9 is shown the means to insert a Plateau into the Program in the present invention. This unique Plateau function provides the means for the user or Program Member or, optionally, a Program Associate to suspend forward daily progress along the current term of the Program Profile and remain at the current Daily Allotment of Communication Events/Program Markers for a period comprised of Program Days before resuming, and continuing forward Program progress along the remaining portion of the term of the Program Profile from the point where it was suspended and the Plateau period began.

A Plateau is requested by means of a Program Input Code or initiated by means of a Program Input Signal (902) by a Program Member (900) or, optionally, a Program Associate (901), which is received by the Communications Handler (903) and passed to or made available by query loop to the Computer Program or software. The Computer Program obtains the Plateau request or signal and queries (904) the Program Member's Program Schedule Table in the Program Service Database (906) to determine if the Program Member's Program Schedule is already currently in a Plateau, and stores the Plateau request or signal in the Program Member's Program Input Code Table (905) in the Program Member's Program Schedule Table in the Program Service Database (906).

The Program Service Database contains a multiplicity of tables. The first table referenced by FIG. 9, the Program Member Program Schedule Table, contains a multiplicity of fields, the following 4 of which are referenced: 1) Program Member Identification; 2) Previous Day's Program Day Schedule's Allotment of Communication Events/Program Markers, or specified Allotment of Communication Events/Program Markers associated with the requested Plateau; 3) Date/Time of Start of Plateau; and 4) Date/Time of End of Plateau.

The second table referenced by FIG. 9, the Program Member Program Input Code Table, contains a multiplicity of fields, the following 3 of which are referenced: 1) Date and Time of Program Input Code receipt; 2) Program Input Code Type; and 3) Program Input Code Value (optional).

If the Program Member's Program is already currently in a Plateau (907), then the requested or signaled Plateau in the Program Member's Program Schedule is, optionally, invalid (908) and the Computer Program instructs the Communications Handler (903) to notify (909) the Program Member and/or, optionally, notify (910) Program Associates that the Plateau request or signal is invalid and denied. If the Program Member's Program is not already currently in a Plateau (907), then the requested or signaled Plateau in the Program Member's Program Schedule is valid.

For the specified requested Plateau Range D1 to D2, where D1 and D2 are a Starting and Ending Date for the Plateau, the current Program Day in the Program Member's Program Profile (the Daily Allotment of Communication Events/Program Markers) will be set to stay fixed at the level set for (D1 minus 1, prior day before Plateau start), or optionally set to a specific Plateau-associated number of Communication Events/Program Markers, and will resume and continue at the regular Program Profile levels after the D2 Date is reached for this Program Member (911).

The Computer Program then instructs (912) the Communications Handler (903) to notify (909) the Program Member and/or, optionally, notify (910) Program Associates that the Plateau request or signal is valid and that the requested or signaled Plateau has been successfully inserted into their Program Profile and Schedule.

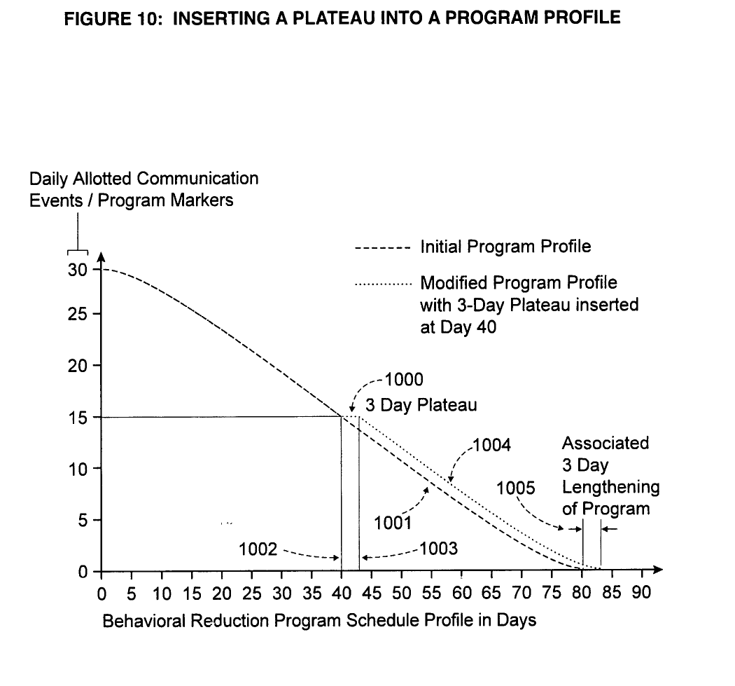

As depicted in FIG. 10, inserting a Plateau (1000) in a Program Member's Program Profile (1001) is accomplished by setting a Plateau date range D1 (1002) through day D2 (1003). The Program Profile already calculated for the Program Member is used in such a manner that at day D1, or optionally D1−1 (day prior to start of Plateau range), the number of Communication Events/Program Markers calculated and/or scheduled for that day is fixed at the level described by day (D1−1). After D2 date has elapsed, the Program Member is returned to the remaining portion of their Program Schedule (1004), with a Program Daily COMMUNICATION EVENT/PROGRAM MARKER Allotment as calculated and/or scheduled for the remaining original portion of their Program and Schedule of daily allotted P.M.s/C.E.s as were previously scheduled to continue on from D1, or optionally D1−1. The overall tentatively scheduled Program calendar length is correspondingly lengthened (1005) by the same amount of time as the Plateau.

### EXAMPLE

Program Member's Program Profile specifies or it is calculated that on day 40 there are 16 Communication Events/Program Markers allotted. On day 41 there are 15 Communication Events/Program Markers allotted, on day 42 there are 15 Communication Events/Program Markers allotted, and day 43 there are 14 Communication Events/Program Markers allotted. If a Plateau is set for days 40, 41, and 42, then on day 40 the level of Communication Events/Program Markers is set to D1, or optionally to D1−1. In this example, day 40's allotment of 16 Communication Events/Program Markers. On days 41, 42, and 43 of the Plateau, again the level is set to D1, which in this example are day 40's allotment of 16 Communication Events/Program Markers. On day 44, following the Plateau, the daily COMMUNICATION EVENT/PROGRAM MARKER Allotment Calculation and/or Schedule returns, beginning from the D+1, or optionally D, Daily COMMUNICATION EVENT/PROGRAM MARKER Allotment Calculation and/or Schedule, continuing on through the rest of the calendar days as if the Plateau had never been inserted or had not interrupted the original schedule and profile.

Plateaus can be configured to any length, or can be constrained to allowable numbers of days (e.g.: one to three days in length).

In another embodiment, which addresses the needs of a Program Member who may only realize that he or she needs/wants a Plateau at the previous day's level after he or she has already moved forward to a day where their Program Daily COMMUNICATION EVENT/PROGRAM MARKER Allotment has dropped down to fewer Communication Events/Program Markers, the Plateau could always be set to the number of Communication Events/Program Markers of the previous day's Program Day Schedule (D−1), and resume again after the Plateau at (D).

Such a method enables Program Members to request Plateaus that will allow time to acclimate and adjust in order to be ready once more to continue on the Program.

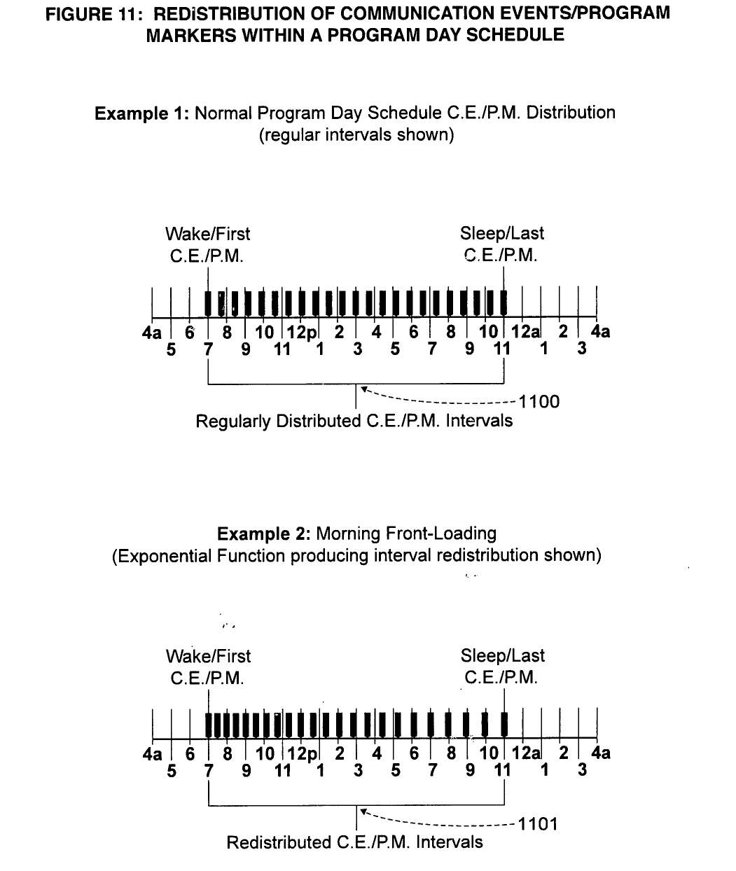

FIG. 11 shows the redistribution of Communication Events/Program Markers within a Program Day Schedule can occur in various ways such as a response to a specific request or program cue by a program member, or by a specific request of a coach, counselor, or other external stimuli.

### EXAMPLE 1

A standard linear (regular interval) program day schedule is shown by (1100). The wake/first Communication Event/Program Marker is at 7:00 am. The Program Day Schedule is 16 hours in length, and contains a total of 23 Communication Events/Program Markers. To determine the standard (regular interval) interval time, the total time of 16 hours is divided by 23. The result is an interval time of 41.7 minutes between each Communication Event/Program Marker. This is an example of regularly distributed Communication Event/Program Markers in a given Program Day Schedule. The Program Day Schedule is 16 hours in length, and contains a total of 23 Communication Events/Program Markers. To determine the standard (regular interval) interval time, the total time of 16 hours is divided by 23. The result is an interval time of 41.7 minutes between each Communication Event/Program Marker. This is an example of regularly distributed Communication Event/Program Markers in a given Program Day Schedule.

### EXAMPLE 2

A “front-loading” or compression effect is shown by (1101). While the wake/first Communication Event/Program Marker, and the sleep/last Communication Event/Program Marker are still at 7:00 AM and 11:00 PM respectively, the intervals between each are not regularly distributed or fixed at 41.7 minutes. Instead a customized time compression and expansion is applied to compress the time between intervals earlier in the Program Day Schedule, with a gradual expansion as the program day schedule approaches the sleep/last Communication Event/Program Marker time frame. A standard exponential function could be applied to produce such a compression/expansion effect on the time intervals.

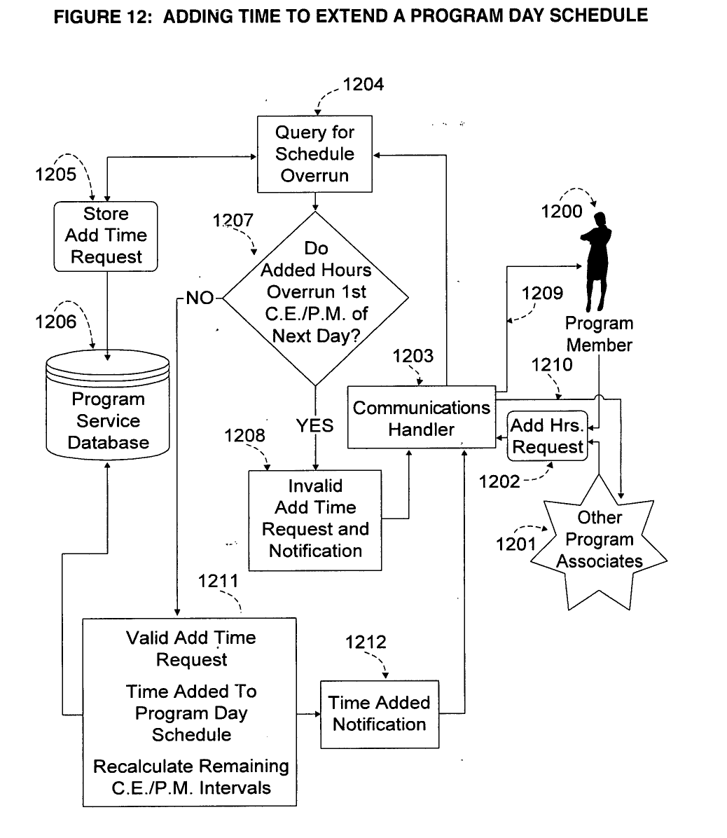

In FIG. 12 as herein disclosed, the Add Time function provides the means for a Program Member or, optionally, a Program Associate to add time to a Program Day Schedule, which is the Active portion of a Program Day, which is the period of time between the Program Day's Wake/Start/Begin/First Communication Event/Program Marker Date/Time and Sleep/Stop/End/Last Communication Event/Program Marker Date/Time.

Adding time to extend a Program Day Schedule is requested by means of a Program Input Code or initiated by means of a Program Input Signal (1202) by a Program Member (1200) or, optionally, a Program Associate (1201), which is received by the Communications Handler (1203) and passed to or made available by query loop to the Computer Program.

The Computer Program obtains the Add Time request or signal, which contains a value for the desired length of time to add, and queries (1204) the Program Member's Program Schedule Table in the Program Service Database (1206) to determine if adding the requested additional time to the Date/Time of the next Last Tentatively Scheduled Communication Event/Program Marker will overrun the Date/Time of the next Tentatively Scheduled First Communication Event/Program Marker of a following Program Day, and stores the Add Time request or signal in the Program Member's Program Input Code Table (1205) in the Program Member's Program Schedule Table in the Program Service Database (1206).

The Program Service Database contains a multiplicity of tables. The first table referenced by FIG. 12, the Program Member Program Day Schedule Table, contains a multiplicity of fields, the following 4 of which are referenced: 1) Program Member Identification; 2) Program Member's Program Daily Communication Event/Program Marker Allotment Calculation and/or Schedule; 3) Date/Time of last scheduled Communication Event/Program Marker; and 4) Date/Time of next day's first scheduled Communication Event/Program Marker.

The second table referenced by FIG. 12, the Program Member Program Input Code Table, contains a multiplicity of fields, the following 3 of which are referenced:

1) Date and Time of Program Input Code receipt;

2) Program Input Code Type; and

3) Program Input Code Value (optional).

If the requested new, later Date/Time of a Sleep/Stop/End/Last Communication Event/Program Marker Date/Time overruns the next Tentatively Scheduled Wake/Start/Begin/First Communication Event/Program Marker Date/Time of a following Program Day (1207), then the requested lengthening of the Program Member's current Program Day Schedule is invalid (1208) and the Computer Program instructs the Communications Handler (1203) to notify (1209) the Program Member and/or, optionally, notify (1210) Program Associates that the Add Time request or signal is invalid and denied.

This logic covers both situations where the first situation involves an Add Time request or signal occurs during the Active Program Day Period of a current Program Day, for example a Monday, in which case the immediately following Program Day's (Tuesday) Wake/Start/Begin/First Communication Event/Program Marker Date/Time has still only been Tentatively Scheduled, as well as second situation involving an Add Time request or signal occurring during the Inactive portion of a Program Day, or in other words after the Sleep/Stop/End/Last Communication Event/Program Marker Date/Time (Monday night or early Tuesday morning), at which time the immediately following Program Day's (Tuesday) Wake/Start/Begin/First Communication Event/Program Marker Date/Time is already Actively Scheduled. In this second situation, the next Tentatively Scheduled Wake/Start/Begin/First Communication Event/Program Marker Date/Time belongs to the following Program Day (Wednesday), meaning that the Add Time request or signal would need to overrun that Date/Time in order to be invalid.

If the requested new, later Date/Time of a Sleep/Stop/End/Last Communication Event/Program Marker Date/Time does not overrun the next Tentatively Scheduled Wake/Start/Begin/First Communication Event/Program Marker Date/Time of a following Program Day (1207), then the requested lengthening of the Program Member's current Program Day Schedule is valid. The Computer Program adds the requested or signaled amount of time to the last scheduled Communication Event/Program Marker Date/Time of the appropriate Program Day Schedule (1211).

If the appropriate Program Day Schedule is the currently Active Program Day Schedule, the Computer Program also recalculates the remaining current Program Day's Program Day Scheduled Communication Events/Program Markers based on the amount of time remaining in the newly lengthened Program Day Schedule divided by the number of Communication Events/Program Markers remaining in the Current Program Day Schedule to determine the new Tentatively Scheduled Interval between Communication Events/Program Markers.

The Computer Program then instructs (1212) the Communications Handler (1203) to notify (1209) the Program Member and/or, optionally, notify (1210) Program Associates that the Add Time request or signal is valid and that the requested or signaled amount of time has been successfully added to their Program Day Schedule.

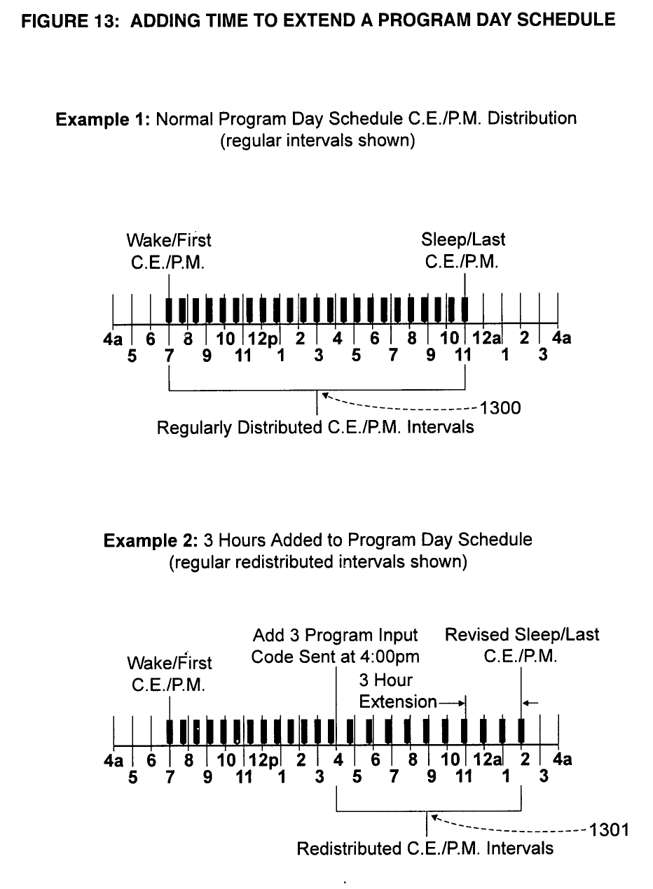

FIG. 13 shows an example of adding time to a Program Day Schedule is determined by calculating the total time between the time of the Program Day Schedule extension request and the scheduled Sleep/Last Communication Event/Program Marker. This revised total time is divided by the total remaining Communication Events/Program Markers for that day to determine the new inter-Communication Event/Program Marker interval. This interval is used for the subsequent Communication Events/Program Markers for the rest of that particular Program Day Schedule.

### EXAMPLE 1

A standard linear (regular interval) Program Day Schedule is shown by (1300). The wake/first Communication Event/Program Marker is at 7:00 AM. The Program Day Schedule is 16 hours in length, and contains a total of 23 Communication Events/Program Markers. To determine the evenly distributed (regular interval) interval time, the total time of 16 hours is divided by 23. The result is an interval time of 41.7 minutes between each Communication Event/Program Marker. This is an example of regularly distributed Communication Events/Program Markers in a given Program Day Schedule.

### EXAMPLE 2

Add 3 Program input code is sent at 4:00 PM. 10 Communication Events/Program Markers remain, at a current interval of 41 minutes. Adding 3 hours to the day, the last scheduled time moves from 11 PM to 2 AM the following day. The new interval calculation is determined by taking the total remaining time for today's Program Day Schedule (1301) (4:00 PM to 2:00 AM) or 10 hours divided by 10 remaining Communication Events/Program Markers=1 hour interval.

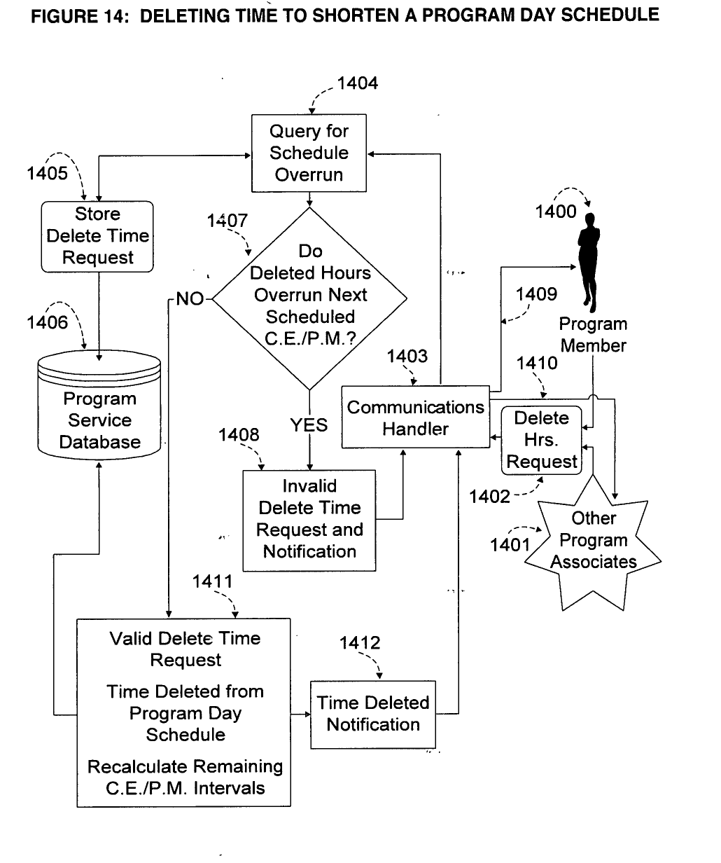

In FIG. 14 if the disclosure of the present invention, the Delete Time function provides the means for a Program Member or, optionally, a Program Associate to subtract time from a Program Day Schedule, which is the Active portion of a Program Day, which is the period of time between the Program Day's Wake/Start/Begin/First Communication Event/Program Marker Date/Time and Sleep/Stop/End/Last Communication Event/Program Marker Date/Time.

Deleting time to shorten a Program Day Schedule is requested by means of a Program Input Code or initiated by means of a Program Input Signal (1402) by a Program Member (1400) or, optionally, a Program Associate (1401), which is received by the Communications Handler (1403) and passed to or made available by query loop to the Computer Program.

The Computer Program obtains the Delete Time request or signal, which contains a value for the desired length of time to subtract, and queries (1404) the Program Member's Program Schedule Table in the Program Service Database (1406) to determine if deleting the requested time from the Date/Time of the next Last Tentatively Scheduled Communication Event/Program Marker will overrun the Date/Time of the next Tentatively or Actively Scheduled Communication Event/Program Marker, and stores the Delete Time request or signal in the Program Member's Program Input Code Table (1405) in the Program Member's Program Schedule Table in the Program Service Database (1406).

The Program Service Database contains a multiplicity of tables. The first table referenced by FIG. 14, the Program Member Program Day Schedule Table, contains a multiplicity of fields, the following 4 of which are referenced: 1) Program Member Identification; 2) Program Member's Program Daily Communication Event/Program Marker Allotment Calculation and/or Schedule; 3) Date/Time of last scheduled Communication Event/Program Marker; and 4) Date/Time of next scheduled Communication Event/Program Marker.

The second table referenced by FIG. 14, the Program Member Program Input Code Table, contains a multiplicity of fields, the following 3 of which are referenced:

1) Date and Time of Program Input Code receipt;

2) Program Input Code Type; and

3) Program Input Code Value (optional).

If the requested new, earlier Date/Time of a Sleep/Stop/End/Last Communication Event/Program Marker Date/Time overruns the next Tentatively or Actively Scheduled Communication Event/Program Marker Date/Time (1407), then the requested shortening of the Program Member's current Program Day Schedule is invalid (1408) and the Computer Program instructs the Communications Handler (1403) to notify (1409) the Program Member and/or, optionally, notify (1410) Program Associates that the Delete Time request or signal is invalid and denied.

If the requested new, earlier Date/Time of a Sleep/Stop/End/Last Communication Event/Program Marker Date/Time does not overrun the next Tentatively Scheduled Communication Event/Program Marker Date/Time (1407), then the requested shortening of the Program Member's Program Day Schedule is valid. The Computer Program subtracts the requested or signaled amount of time from the last scheduled Communication Event/Program Marker Date/Time of the appropriate Program Day Schedule (1411).

If the appropriate Program Day Schedule is the currently Active Program Day Schedule, the Computer Program also recalculates the remaining current Program Day's Program Day Scheduled Communication Events/Program Markers based on the amount of time remaining in the newly lengthened Program Day Schedule divided by the number of Communication Events/Program Markers remaining in the Current Program Day Schedule to determine the new Tentatively Scheduled Interval between Communication Events/Program Markers.

The Computer Program then instructs (1412) the Communications Handler (1403) to notify (1409) the Program Member and/or, optionally, notify (1410) Program Associates that the Delete Time request or signal is valid and that the requested or signaled amount of time has been successfully deleted from their Program Day Schedule.

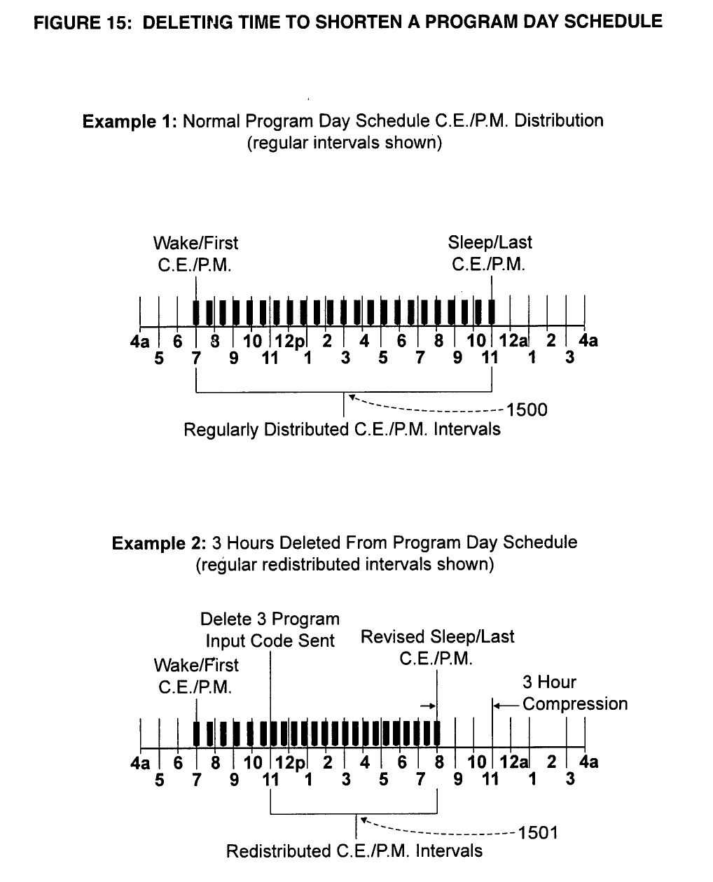

As shown in FIG. 15 deleting time from a Program Day Schedule is determined by calculating the total time between the time of the Program Day Schedule shortening request and the scheduled Sleep/Last Communication Event/Program Marker. This revised total time is divided by the total remaining Communication Events/Program Markers for that day to determine the new inter-Communication Event/Program Marker interval. This interval is used for the subsequent Communication Events/Program Markers for the rest of that particular Program Day Schedule.

### EXAMPLE 1

A standard linear (regular interval) Program Day Schedule is shown by (1500). The wake/first Communication Event/Program Marker is at 7:00 AM. The Program Day Schedule is 16 hours in length, and contains a total of 23 Communication Events/Program Markers. To determine the standard (regular interval) interval time, the total time of 16 hours is divided by 23. The result is an interval time of 41.7 minutes between each Communication Event/Program Marker. This is an example of regularly distributed Communication Events/Program Markers in a given Program Day Schedule.

### EXAMPLE 2

Delete 3 Program input code is sent at 11:00 AM. 17 Communication Events/Program Markers remain, at a current interval of 42.4 minutes. Deleting 3 hours from the day, the last scheduled time moves from 11 PM to 8 PM.

The new interval calculation is determined by taking the new total remaining time for today's revised Program Day Schedule (1501) (11:00 AM to 8:00 PM) or 9 hours divided by 17 remaining Communication Events/Program Markers=31.8 minute interval.

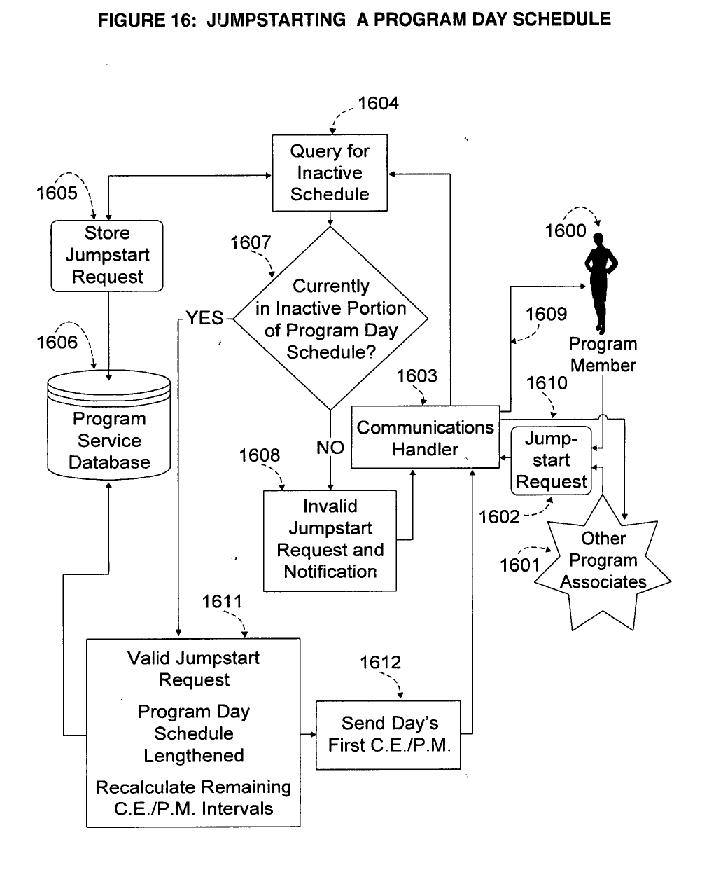

In FIG. 16 of this disclosure of the present invention, the Delete Time function provides the means for a Program Member or, optionally, a Program Associate to Jumpstart a Program Day Schedule earlier than the Actively Scheduled Wake/Start/Begin/First Communication Event/Program Marker Date/Time, resulting in a longer Active portion of a Program Day, which is the period of time between the Program Day's Wake/Start/Begin/First Communication Event/Program Marker Date/Time and Sleep/Stop/End/Last Communication Event/Program Marker Date/Time.

Jumpstarting a Program Day Schedule is requested by means of a Program Input Code or initiated by means of a Program Input Signal (1602) by a Program Member (1600) or, optionally, a Program Associate (1601), which is received by the Communications Handler (1603) and passed to or made available by query loop to the Computer Program.

The Computer Program obtains the Jumpstart request or signal, and queries (1604) the Program Member's Program Schedule Table in the Program Service Database (1606) to determine if the Program Member's Program Schedule is currently between active Program Day Schedules (after the Stop/End/Sleep of one day's Program Day Schedule and before the Start/Begin/Wake of the next day's Program Day Schedule, and stores the Jumpstart request or signal in the Program Member's Program Input Code Table in the Program Member's Program Schedule Table (1605) in the Program Service Database (1606).

The Program Service Database contains a multiplicity of tables. The first table referenced by FIG. 16, the Program Member Program Day Schedule Table, contains a multiplicity of fields, the following 4 of which are referenced: 1) Program Member Identification; 2) Program Member's Program Daily Communication Event/Program Marker Allotment Calculation and/or Schedule; 3) Date/Time of first scheduled Communication Event/Program Marker; and 4) Date/Time of last scheduled Communication Event/Program Marker.

The second table referenced by FIG. 16, the Program Member Program Input Code Table, contains a multiplicity of fields, the following 3 of which are referenced: 1) Date and Time of Program Input Code receipt; 2) Program Input Code Type; and 3) Program Input Code Value (optional).

If the Program Member's Program Schedule is not currently between active Program Day Schedules (after the Stop/End/Sleep of one day's Program Day Schedule and before the Start/Begin/Wake of the next day's Program Day Schedule (1607), then the requested Jumpstart of the Program Member's next Program Day Schedule is invalid (1608) and the Computer Program instructs the Communications Handler (1603) to notify (1609) the Program Member and/or, optionally, notify (1610) Program Associates that the Jumpstart request or signal is invalid and denied.

If the Program Member's Program Schedule is currently between active Program Day Schedules (after the Stop/End/Sleep of one day's Program Day Schedule and before the Start/Begin/Wake of the next day's Program Day Schedule (1607), then the requested Jumpstarting of the Program Member's next Program Day Schedule is valid.

The Computer Program then changes the time of the next Program Day Schedule's first scheduled Communication Event/Program Marker Date/Time to the current Date/Time. (1611).

The Computer Program then recalculates the remaining Program Day Scheduled Communication Events/Program Markers based on the amount of time remaining in the newly lengthened Program Day Schedule divided by the number of Communication Events/Program Markers remaining to determine the new interval between Communication Events/Program Markers.

The Computer Program then instructs (1612) the Communications Handler (1603) to send or display (1609) the Program Day Schedule's first scheduled Communication Event/Program Marker to the Program Member and/or, optionally, notify (1610) Program Associates that the Jumpstart request or signal is valid and that the Program Day Schedule has been successfully started early.

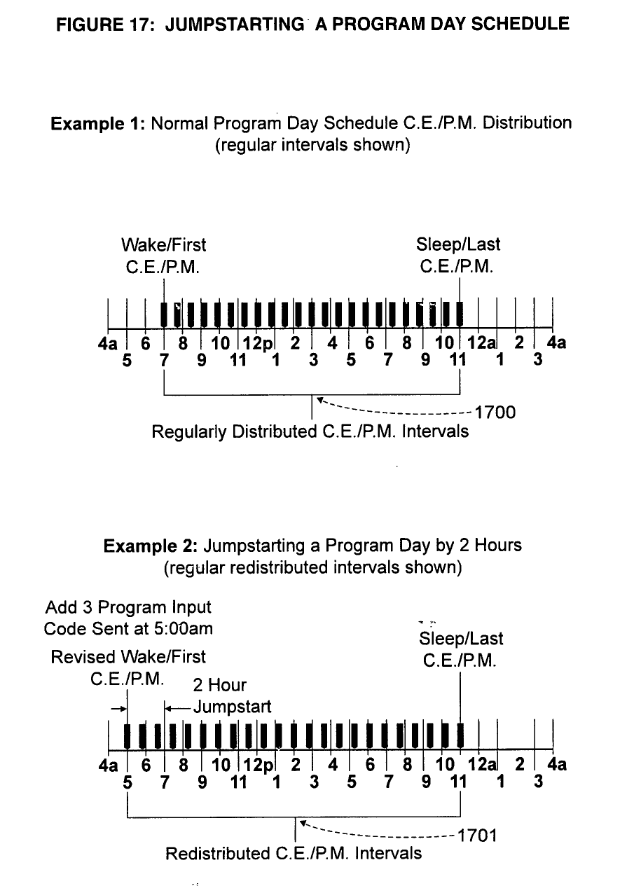

In FIG. 17 it is shown that Jumpstarting a Program Day Schedule is determined by calculating the total time between the time of the Jumpstart request and the scheduled Sleep/Last Communication Event/Program Marker. This total is divided by the total remaining Communication Events/Program Markers for that day to determine the new inter-Communication Event/Program Marker interval. This interval is used for the subsequent Communication Events/Program Markers for the rest of that particular Program Day Schedule.

### EXAMPLE 1

A standard linear (regular interval) Program Day Schedule is shown by (1700). The wake/first Communication Event/Program Marker is at 7:00 AM. The Program Day Schedule is 16 hours in length, and contains a total of 23 Communication Events/Program Markers. To determine the standard (regular interval) interval time, the total time of 16 hours is divided by 23. The result is an interval time of 41.7 minutes between each Communication Event/Program Marker. This is an example of regularly distributed Communication Events/Program Markers in a given Program Day Schedule.

### EXAMPLE 2

Jumpstart Program input code is sent at 5:00 AM. 23 Communication Events/Program Markers remain for the day, at a current interval of 41 minutes. Jumpstarting the day by 2 hours moves the first/wake time of the Communication Event/Program Marker from 7:00 AM to 5:00 AM.

The new interval calculation is determined by taking the total time for today's revised Program Day Schedule (1701) (5:00 AM-11:00 PM) or 18 hours divided by 23 remaining Communication Events/Program Markers=47 minute interval.

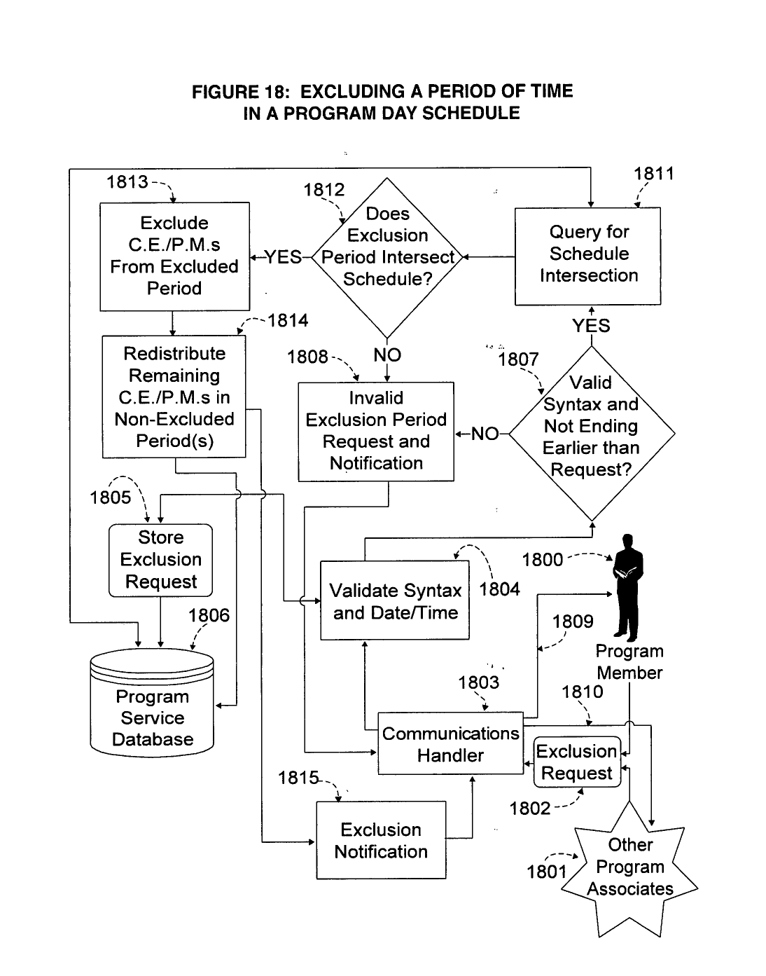

FIG. 18 depicts the operation of the Exclude function provides the means for a Program Member or, optionally, a Program Associate to exclude or block a segment of time within or partially overlapping the Active portion of a Program Day Schedule, resulting in the remaining Communication Events/Program Markers being redistributed within the remaining non-excluded portion or portions of said Program Day Schedule.

Excluding a segment of time within a Program Day Schedule is requested by means of a Program Input Code or initiated by means of a Program Input Signal (1802) by a Program Member (1800) or, optionally, a Program Associate (1801), which is received by the Communications Handler (1803) and passed to or made available by query loop to the Computer Program.

The Computer Program obtains the Exclude request or signal, and queries (1804) the Program Member's Program Day Schedule Table in the Program Service Database (1806) to determine if the requested Exclusion Period Program Input Code is of a valid syntax and the end of the requested Exclusion Period is also not earlier than the Date/Time of the request, and stores the Exclude request or signal in the Program Member's Program Input Code Table (1805) in the Program Member's Program Schedule Table in the Program Service Database (1806).

The Program Service Database contains a multiplicity of tables. The first table referenced by FIG. 18, the Program Member Program Day Schedule Table, contains a multiplicity of fields, the following 4 of which are referenced: 1) Program Member Identification; 2) Program Member's Program Daily Communication Event/Program Marker Allotment Calculation and/or Schedule; 3) Date/Time of beginning of requested Exclusion Period; and 4) Date/Time of ending of requested Exclusion Period.

The second table referenced by FIG. 18, the Program Member Program Input Code Table, contains a multiplicity of fields, the following 3 of which are referenced:

1) Date and Time of Program Input Code receipt;

2) Program Input Code Type; and

3) Program Input Code Value (optional).

If the requested Exclusion Period Program Input Code is not of a valid syntax or the end of the requested Exclusion Period is earlier than the current Date/Time (1807), then the requested Exclusion Period within the Program Member's Program Day Schedule is invalid (1808) and the Computer Program instructs the Communications Handler (1803) to notify (1809) the Program Member and/or, optionally, notify (1810) Program Associates that the Exclusion request or signal is invalid and denied.

If the requested Exclusion Period Program Input Code is a valid syntax and the end of the requested Exclusion Period is not earlier than the current Date/Time (1807), then the Computer Program moves forward (1812) to query the Program Member's Program Day Schedule Table in the Program Service Database (1806) to determine if the requested Exclusion Period intersects the Program Member's currently active Program Day Schedule or one of his or her future Tentative Program Day Schedules.

If the requested Exclusion Period does not intersect the Program Member's currently active Program Day Schedule or a future Tentative Program Day Schedule (1812), then the requested Exclusion Period within the Program Member's Program Day Schedule is invalid (1808) and the Computer Program instructs the Communications Handler (1803) to notify (1809) the Program Member and/or, optionally, notify (1810) Program Associates that the Exclusion request or signal is invalid and denied.

If the requested Exclusion Period does intersect the Program Member's currently active Program Day Schedule or a future Tentative Program Day Schedule (1812), then the requested Exclusion Period within the Program Member's Program Day Schedule is valid.

The Computer Program then Excludes all scheduled Communication Events/Program Markers from the portion of the requested Exclusion Period that intersects with the Program Member's specified Program Day Schedule beginning at the Date/Time contained in the Exclusion Request Program Input Code (1813), and redistributes all remaining Communication Events/Program Markers evenly or according to the existing Program Day Schedule Profile within the remaining time before and/or after the Excluded Period (1814).

The Computer Program then instructs (1815) the Communications Handler (1803) to notify (1809) the Program Member and/or, optionally, notify (1810) Program Associates that the Exclusion request or signal is valid and that the requested period of time has been successfully excluded or blocked.

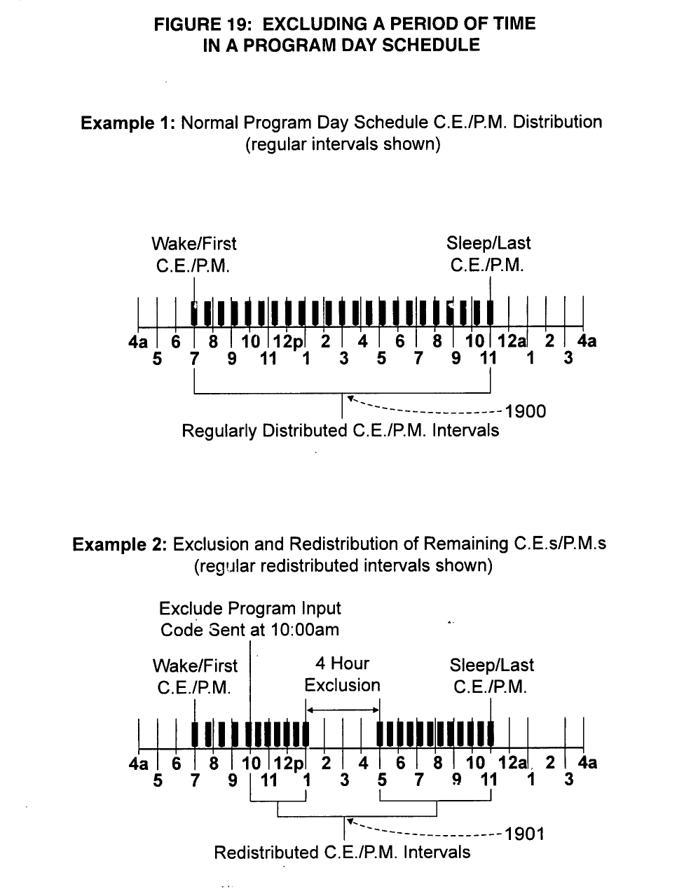

In FIG. 19 excluding part of a Program Day Schedule is accomplished by first determining the total amount of communication events/program markers would have been scheduled for the excluded time segment. This amount needs to be distributed accordingly before and after the excluded segment, depending on the percentage of time in each of the resulting before and after remaining segments in the Program Day Schedule.

### EXAMPLE 1

A standard linear (regular interval) Program Day Schedule is shown by (1900). The wake/first Communication Event/Program Marker is at 7:00 AM. The Program Day Schedule is 16 hours in length, and contains a total of 23 Communication Events/Program Markers. To determine the standard (regular interval) interval time, the total time of 16 hours is divided by 23. The result is an interval time of 41.7 minutes between each Communication Event/Program Marker. This is an example of regularly distributed Communication Events/Program Markers in a given Program Day Schedule.

### EXAMPLE 2

An Exclude Program Input Code is sent at 10:00 AM to exclude the time between 1:00 PM and 5:00 PM (1901), the total number of Communication Events/Program Markers that will be excluded is 5. These 5 need to be equally distributed based on percentage of time in each pre and post blocking segment. In this case, the excluded time is 5 hours. The amount of time remaining before the exclusion at 1:00 PM is 10:00 AM to 1:00 PM, or 3 hours. The total time remaining after the excluded segment ends at 5 PM is 5:00 PM to 11:00 PM, or 6 hours. Total time before and after the excluded segment is 3+6 hours, or 9 total hours. (3/9)*100=33% of the time is represented before the excluded segment, and (6/9)*100=66% of the time is represented after the excluded segment.

The distribution of the 5 cigarettes will be as follows. Before the excluded segment, an additional 5*33%=1.65 or 2 (rounded up) Communication Events/Program Markers will be inserted. After the excluded segment, an additional 5*66%=3 Communication Events/Program Markers will be inserted.

A new interval amount will be calculated for each before and after the excluded segment based on dividing the total time in the new segment, in this case between 10:00 AM and 1:00 PM, by the total Communication Events/Program Markers (4+2=6 markers). The same calculation applies to after the excluded segment between the times 5 PM and 11 PM divided by the new total remaining Communication Events/Program Markers (9+3=12).

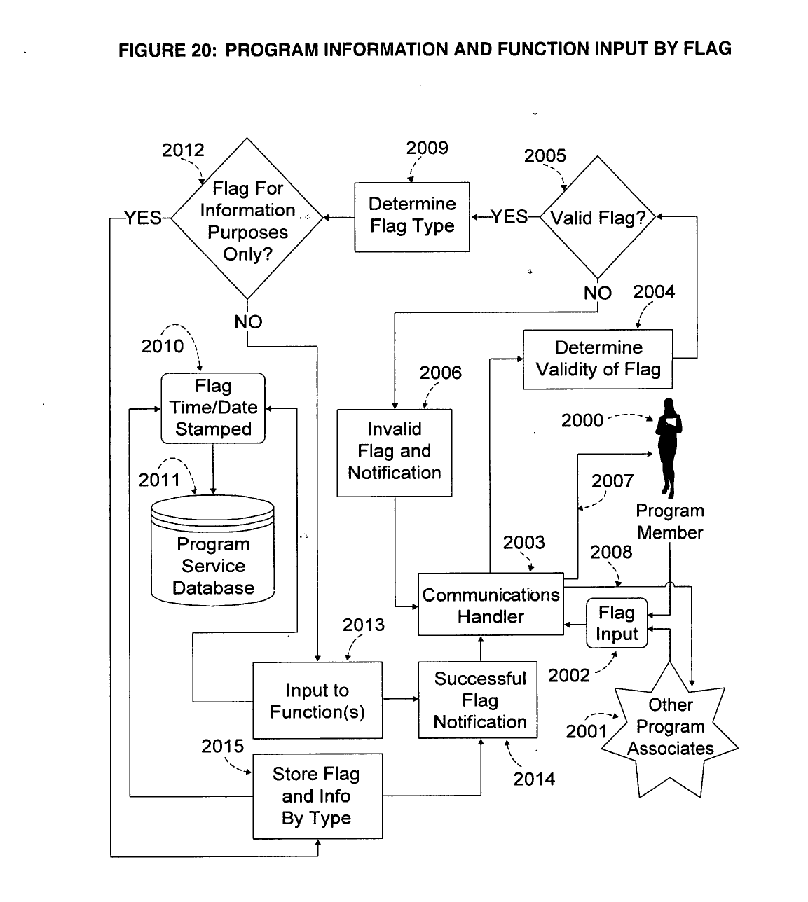

As shown in FIG. 20 the present invention provides the means for a Program Member or, optionally, a Program Associate to enter into the Program Member's Program Record Flags, which may contain information, notations, or descriptions of things including, but not limited to, events, or states, issues, rated or categorized input, and/or answers to questions, and which, optionally, may further be associated with particular points or time periods or segments along the calendar timeline of a Program Member's Program Record and/or individual Program Day Schedule Records.

Flagging within a Program Member's Program Schedule and/or Program Day Schedule is requested by means of a Program Input Code or initiated by means of a Program Input Signal (2002) by a Program Member (2000) or, optionally, a Program Associate (2001), which is received by the Communications Handler (2003) and passed to or made available by query loop to the Computer Program.

The Computer Program obtains the Flag Program Input Code, and determines if the Flag Program Input Code is of a valid type (2004).

If the Program Input Code is not among the valid types of Flags (2005), the Program Input Code is invalid (2006) and the Computer Program instructs the Communications Handler (2003) to notify (2007) the Program Member and/or, optionally, notify (2008) Program Associates that the Flag Program Input Code is invalid and denied. If the Program Input Code is among the valid types of Flags (2005), the Program Input Code is valid (2006) and the Computer Program determines if the Flag is of a Flag type that's used for information gathering only (2009).

If the Flag Program Input Code is not among the Flag types used for information gathering only (2012), then the Computer Program uses the recognized Flag and optional associated objective or subjective state and/or value information as input for Flag-matched functions that can alter Program and/or Program Day Schedule Profile 2013), and the Computer Program executes said associated function and makes associates changes to the Program Member's Program and/or Program Day Schedule Profile, and stores the Flag data with the current Date/Timestamp in the Program Member's Program Input Code Table (2010) in the Program Service Database (2011).

The Computer Program then instructs (2014) the Communications Handler (2003) to notify (2007) the Program Member and/or, optionally, notify (2008) Program Associates that the Flag Program Input code is valid, was stored in the Program Member's Program Record and, optionally, any associated function, if already executed, has been successfully executed. Some functions may require an accumulated number of Flags or conditions to be reached or occur, prior to executing an associated function.

If the Flag Program Input Code is among the Flag types used for information gathering only (2012), then the Computer Program stores the recognized Flag and optional associated objective or subjective state and/or value information with the current Date/Timestamp (2015) in the Program Member's Program Input Code Table (2010) in the Program Service Database (2011).

The Computer Program then instructs (2014) the Communications Handler (2003) to notify (2007) the Program Member and/or, optionally, notify (2008) Program Associates that the Flag Program Input code is valid, and was stored in the Program Member's Program Record. The Program Service Database contains a multiplicity of tables. The table referenced by FIG. 20, the Program Member Program Day Schedule Table, contains a multiplicity of fields, the following 4 of which are referenced:

1) Program Member Identification;

2) Date and Time of Flag receipt;

3) Flag Type; and 4) Flag Value (optional).

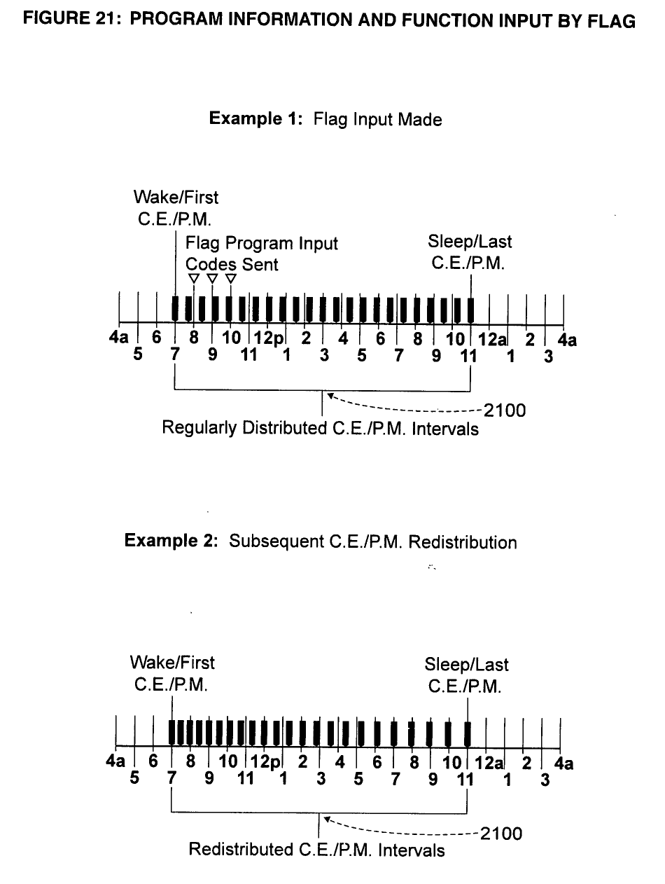

As shown in FIG. 21 Flagging can be used by Program Members, coaches, guides, and/or can be triggered by other conditions or resulting from other external input. Flags can be simple markers of points in time in a Program and/or Program Day Schedule, can additionally include associated objective or subjective state and/or value information, and may also be subsequently used by the Program Server to reshape the Program and/or Program Day Schedule.

### EXAMPLE 1

When the invention is used for a smoking cessation program based on the Gradual Reduction Method, a Program member has a standard linear program day schedule in effect. The wake/first communication event/program marker is set at 7:00 AM and the and the sleep/last Communication Event/Program Marker is scheduled for 11:00 PM.

With a 16 hour total time for the program day, and 23 communication events/program markers scheduled, the interval between events is calculated as 16 hours/23=41.7 minutes.

If the program member sends Flags which are understood to signify discomfort at 8:00 AM, 9:00 AM and 10:00 AM (2100), and if such input amounts are determined to be at a level to change the program day schedule based on pre-defined criteria, the program day schedule will be modified in real-time to reflect the program member's input. In this case, a compression effect is applied to adjust the interval time period near the program member's behavioral state cue input data, which lessens the interval time from 41.7 to a shorter amount. By shortening the interval, the remaining intervals for the program day schedule following the adjusted period will be recalculated.

### EXAMPLE 2

The Computer Program includes a function to look for a certain amount of feedback in the form of Flags and/or Flags with associated values or descriptive information until a threshold or condition is reached, whereupon it will respond by altering or reconfiguring the Program or Program Day Schedule. The Flag Program Input Codes received during the morning were understood by the Program Member and the Computer Program as representing points of discomfort. The Computer Program interprets the three Flag Program Input Codes as being enough to trigger a reconfiguration of the Program Day Schedule Profile, and in this example, it responds by implementing a Morning Front-Loading profile (2101) so that the Program Member is receiving additional Communication Events/Program Markers toward the beginning of the day.

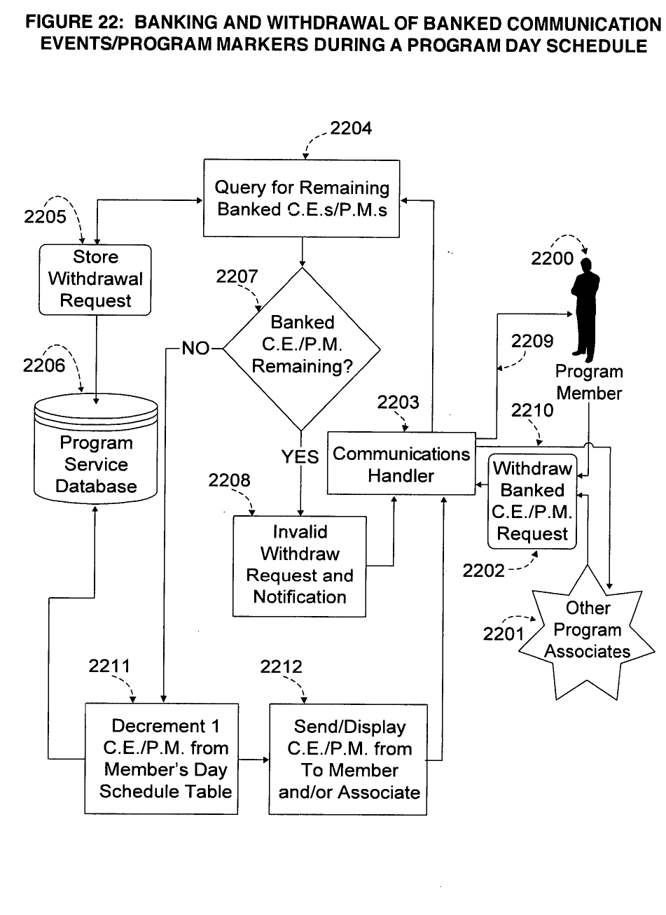

In FIG. 22 it is shown further that the present invention provides the means for a certain number of Communication Events/Program Markers to be set aside, or Banked, so that these can be requested, or Withdrawn, by the Program Member or, optionally, Program Associates acting on behalf of the Program Member, or automatically by means of signals generated upon recognition of specified events, conditions, and/or states.

Banking of a certain number or percentage of Communication Events/Program Markers in a Program Member's Program Day Schedule can be specified and enabled as part of a Program's ongoing Program Profile and Program Day Schedule Profiles, or can be specified on an irregular basis via Program Input Codes or equivalent means by Program Members or, optionally, Program Associates, or automatically by means of signals generated upon recognition of specified events, conditions, and/or states.

Withdrawal of Banked Communication Events/Program Markers in a Program Day Schedule can be made at any time between the Wake/Start/Begin/First Communication Event/Program Marker Date/Time of a currently active Program Day and the Wake/Start/Begin/First Communication Event/Program Marker Date/Time of the following day. Status on the number of remaining Banked Communication Events/Program Markers can be obtained along with other up-to-date Program and Program Day Schedule statistics through the Request Status Program Input Code or equivalent means of request.

Withdrawing a Banked Communication Event/Program Marker is requested by means of a Program Input Code or initiated by means of a Program Input Signal (2202) by a Program Member (2200) or, optionally, a Program Associate (2201), which is received by the Communications Handler (2203) and passed to or made available by query loop to the Computer Program.

The Computer Program obtains the Withdrawal request or signal, and queries (2204) the Program Member's Program Day Schedule Table in the Program Service Database (2206) to determine the amount of available Banked Communication Events/Program Markers, and stores the Withdrawal request or signal in the Program Member's Program Input Code Table (2205) in the Program Member's Program Schedule Table in the Program Service Database (2206).

The Program Service Database contains a multiplicity of tables. The first table referenced by FIG. 22, the Program Member Program Day Schedule Table, contains a multiplicity of fields, the following 4 of which are referenced:

1) Program Member Identification;

2) Program Member's Program Daily Communication Event/Program Marker Allotment Calculation and/or Schedule; and

3) Remaining Banked Communication Events/Program Markers.

The second table referenced by FIG. 22, the Program Member Program Input Code Table, contains a multiplicity of fields, the following 3 of which are referenced:

1) Date and Time of Program Input Code receipt;

2) Program Input Code Type; and

3) Program Input Code Value (optional).

If the Program Member doesn't have any Banked Communication Events/Program Markers available for Withdrawal (2207), then the requested Withdrawal is invalid (2208) and the Computer Program instructs the Communications Handler (2203) to notify (2209) the Program Member and/or, optionally, notify (2210) Program Associates that the Withdrawal request or signal is invalid and denied.

If the Program Member does have remaining Banked Communication Events/Program Markers available for Withdrawal (2207), then the requested Withdrawal is valid, and the Computer Program decrements a Banked Communication Event/Program Marker from the Program Member's Program Day Schedule Table (2211).

The Computer Program then instructs (2212) the Communications Handler (2203) to send or display (2209) the Withdrawn Communication Event/Program Marker to the Program Member and/or, optionally, notify (2210) Program Associates that the Withdrawal request or signal is valid and that the Communication Event/Program marker has been successfully withdrawn.

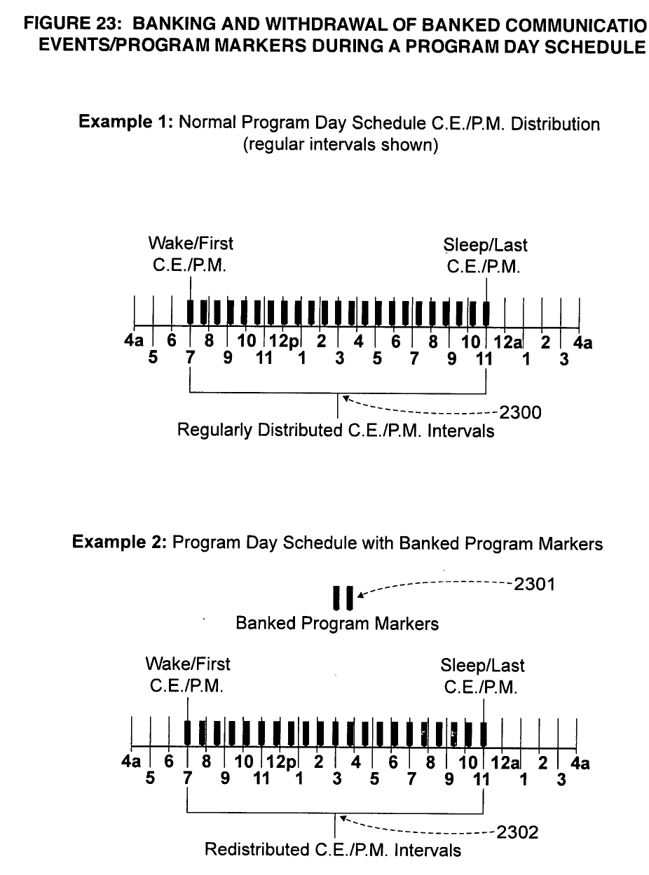

In FIG. 23 it is shown that during the calculation of the Program Member's Program Profile, the Program Member can choose whether or not they want to have some of their Communication Events/Program Markers to “bank” for the current Program Day Schedule. If they choose this option, a certain percentage of their scheduled Communication Events/Program Markers will be “banked”, and set aside.

A Program Member has the option of Withdrawing or requesting “banked” Communication Events/Program Markers one at a time at any time between the Start of a day's Program Day Schedule and the Start of the next day's Program Day Schedule. A Program Member redeems or requests a “banked” marker by sending a Withdraw request to the Program Server via the Communication Server.

### EXAMPLE 1

A standard linear (regular interval) Program Day Schedule is shown by (2300). The wake/first Communication Event/Program Marker is at 7:00 AM. The Program Day Schedule is 16 hours in length, and contains a total of 23 Communication Events/Program Markers. To determine the standard (regular interval) interval time, the total time of 16 hours is divided by 23. The result is an interval time of 41.7 minutes between each Communication Event/Program Marker. This is an example of regularly distributed Communication Events/Program Markers in a given Program Day Schedule.

### EXAMPLE 2

Two of the 23 Communication Events/Program Markers in the Program Day Schedule are Banked (2301), leaving 21 Communication Events/Program Markers to be redistributed between the Wake/First time and the Sleep/Last time (2302).

The Program Member is free to send a Withdraw Program Input Code at any time between the Start of the current day's Program Day Schedule and the Start of the next day's Program Day Schedule. This allows flexibility for the Program Member to use them when desired or needed to fit the dynamic and ever-changing schedule of their daily life.

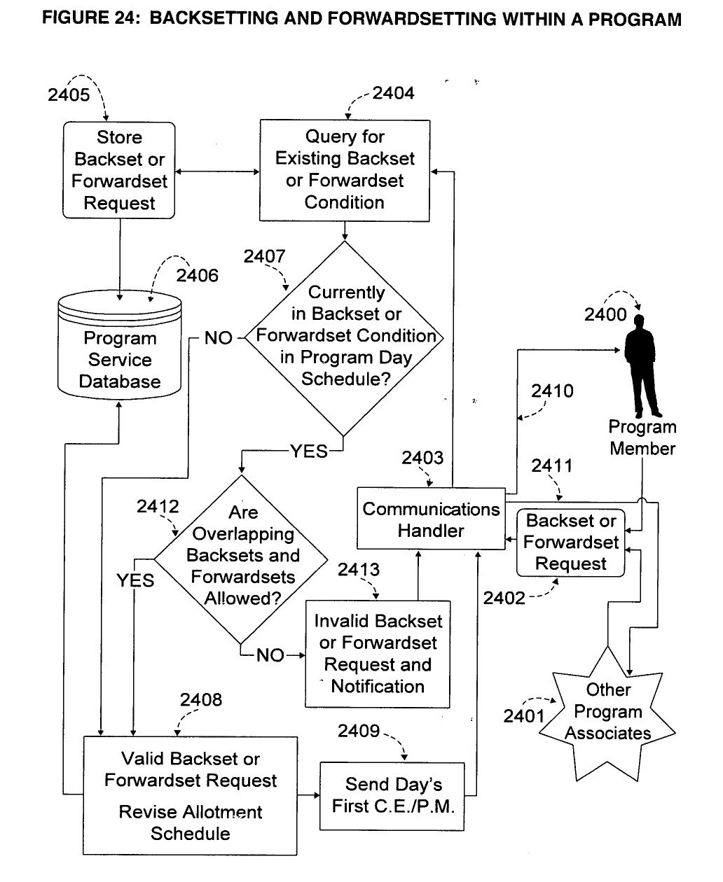

In FIG. 24 of the present invention is shown the provision of means for a Program Member or, optionally, a Program Associate to reset a Program Member's or participant's current associated behavioral prompting parameters within a Program, through the Backsetting and Forwardsetting functions. In increasing or decreasing programs, this is equivalent to moving the Program Member ahead or back within the Program.

Backsetting and Forwardsetting is requested by means of a Program Input Code or initiated by means of a Program Input Signal (2402) by a Program Member (2400) or, optionally, a Program Associate (2401), which is received by the Communications Handler (2403) and passed to or made available by query loop to the Computer Program.

The Computer Program obtains the Withdrawal request or signal, and queries (2404) the Program Member's Program Schedule Table in the Program Service Database (2406) to determine if the Program Member's Program Schedule is already currently in a Backset or Forwardset Condition, and stores the Backsetting or Forwardsetting request or signal in the Program Member's Program Input Code Table (2405) in the Program Member's Program Schedule Table in the Program Service Database (2406).

The Program Service Database contains a multiplicity of tables. The first table referenced by FIG. 24, the Program Member Program Schedule Table, contains a multiplicity of fields, the following 3 of which are referenced: 1) Program Member Identification; 2) Revised Program Communication Event/Program Marker Daily Allotment Calculation or Schedule with associated longer or shorter tentatively scheduled Program Calendar Length; and 3) Revised Current Program Day's, or optionally Following Program Day's, location within the Revised Program Communication Event/Program Marker Daily Allotment Schedule, or optionally re-calculated Daily Allotment, and its associated Increased or Decreased Allotment of Communication Events/Program Markers.

The second table referenced by FIG. 24, the Program Member Program Input Code Table, contains a multiplicity of fields, the following 3 of which are referenced:

1) Date and Time of Program Input Code receipt;

2) Program Input Code Type; and

3) Program Input Code Value (optional).

If the Program Member's Program Schedule is already currently in a Backset or Forwardset condition (2407), and simultaneous or overlapping Backset or Fowardset conditions are not allowed in the Program, then the requested Backsetting or Forwardsetting is invalid (2413) and the Computer Program instructs the Communications Handler (2403) to notify (2410) the Program Member and/or, optionally, notify (2411) Program Associates that the Backsetting or Forwardsetting of the Program Communication Event/Program Marker Daily Allotment Schedule is invalid and denied.

If the Program Member's Program Schedule is already currently in a Backset or Forwardset condition (2407), and simultaneous or overlapping Backset or Fowardset conditions are allowed in the Program, then the requested Backsetting or Forwardsetting of the Program Communication Event/Program Marker Daily Allotment Schedule is valid.

The Computer Program then revises the Program Member's Program Communication Event/Program Marker Daily Allotment Schedule and its associated longer or shorter tentatively scheduled Program Calendar Length (2408). The Computer Program then revises the Current Program Day's or, optionally, Following Program Day's location within the Revised Program Communication Event/Program Marker Daily Allotment Schedule and switches to or assigns its associated Increased or Decreased Allotment of Communication Events/Program Markers.

The Computer Program then instructs (2409) the Communications Handler (2403) to notify (2410) the Program Member and/or, optionally, notify (2411) Program Associates that the Backsetting or Forwardsetting request or signal is valid and that the Program Member's Program has been successfully Backset or Forwardset. If the Program Member's Program Schedule is not already currently in a Backset or Forwardset condition (2407), then the requested Backsetting or Forwardsetting of the Program Communication Event/Program Marker Daily Allotment Schedule is valid. The Computer Program then revises the Program Member's Program Communication Event/Program Marker Daily Allotment Schedule and its associated longer or shorter tentatively scheduled Program Calendar Length (2408).

The Computer Program then revises the Current Program Day's or, optionally, Following Program Day's location within the Revised Program Communication Event/Program Marker Daily Allotment Schedule and switches to or assigns its associated Increased or Decreased Allotment of Communication Events/Program Markers.

The Computer Program then instructs (2409) the Communications Handler (2403) to notify (2410) the Program Member and/or, optionally, notify (2411) Program Associates that the Backsetting or Forwardsetting request or signal is valid and that the Program Member's Program has been successfully Backset or Forwardset.

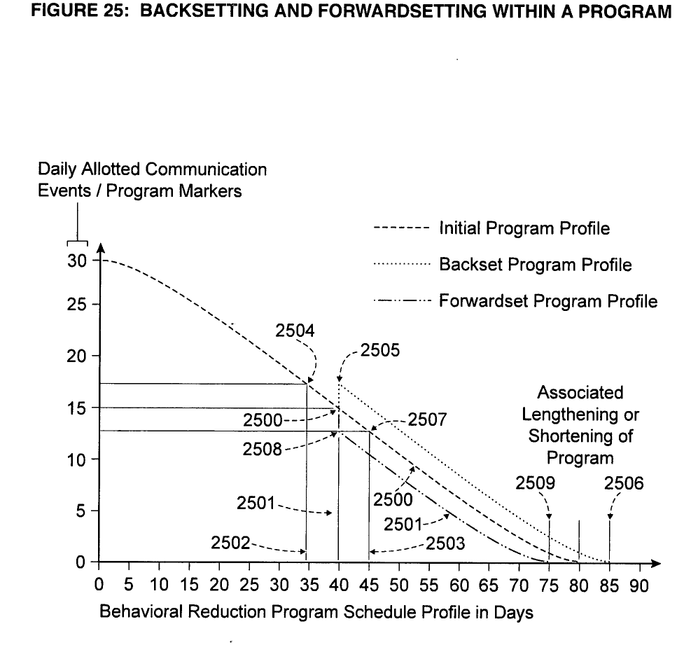

In FIG. 25 backsetting and Forwardsetting as shown allows a Program Member's current position within a Program Member's Program Profile and Schedule (2500), corresponding in the example above to Day 40 (2501) of an tentatively scheduled 80-Day Program to be moved backward (2502) or forward (2503) respectively.

In the example of a reduction-oriented program, Backsetting resets the Program Member's position to an earlier and higher daily allotment of Communication Events/Program Markers (2504) and proceed thereafter to resume advancing the Program forward again from the earlier or regressed position and/or daily allotment of Communication Events/Program Markers (2505). The Program's tentatively scheduled calendar length will be lengthened by a period of time equal to the amount of Program time repeated by the Backsetting (2506).

Correspondingly, and also in the example of a reduction-oriented program, Forwardsetting resets the Program Member's position forward to a later and lower number of Communication Events/Program Markers (2507) and proceed thereafter to resume advancing the Program forward from the later or advanced position and/or daily allotment of Communication Events/Program Markers (2508). The Program's tentatively scheduled calendar length will be shortened by a period of time equal to the amount of Program time skipped over by the Forwardsetting (2509).

### EXAMPLE 1

Program Member's Program Profile specifies or it is calculated that on day 40 there are 16 Communication Events/Program Markers allotted. A request to Backset the Program to either Day 35 or 18 allotted Communication Events/Program Markers will result repeating the Program Profile and Schedule between Day 35 and Day 40, and add a corresponding five days to the total tentatively scheduled Program Calendar Length.

### EXAMPLE 2

Program Member's Program Profile specifies or it is calculated that on day 40 there are 16 Communication Events/Program Markers allotted. A request to Forwardset the Program to either Day 45 or 13 allotted Communication Events/Program Markers will result in skipping over the period between Day 40 and Day 45 in the Program Profile and Schedule, and subtract a corresponding five days from the total tentatively scheduled Program Calendar Length.

Such a method enables Program Members who are out of synchronization with where they're supposed to be in the Program at the current time. They may be having significant difficulty or significant lack of challenge at the current position in their Program Profile and Schedule. Backsetting and Forwardsetting allows them to move backward or forward in response, thus readjusting and resetting the Program to their current actual state, needs, or behavioral profile.

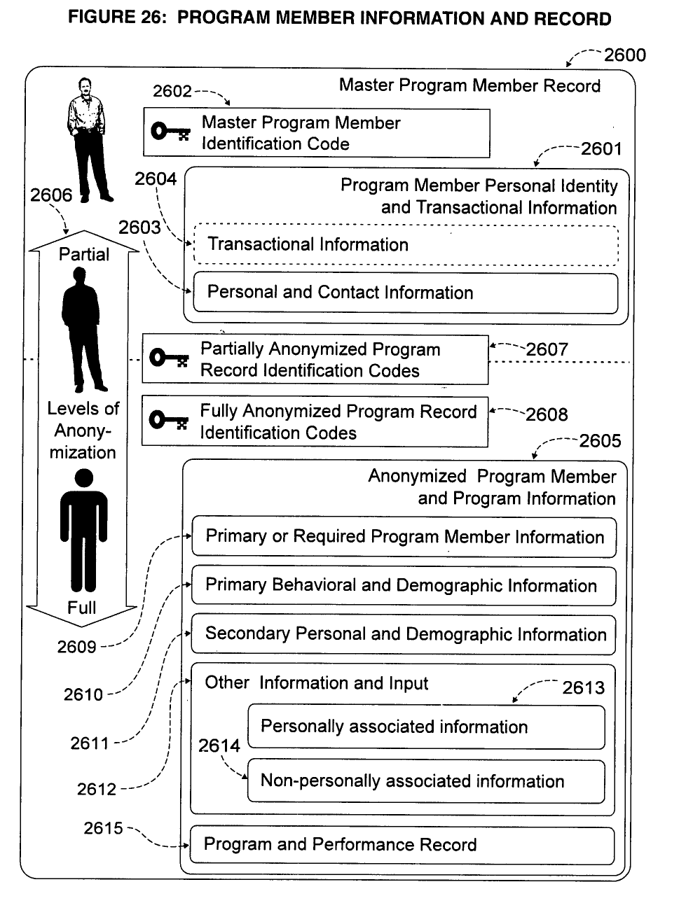

In FIG. 26 it is shown that the present invention includes the means to register Program Members, record their personal identification, payment transaction information, demographic, psychographic, and sociographic information, and track their Program-related behavior and information during an active behavioral modification and/or maintenance program.

A Program Member record, which in total comprises the complete Master Program Record (2600), and which is total is made secure and accessible by authorized parties via the Master Program Member Identification Code (2602), is divided into two primary portions, the first portion being the Program Member Personal Identity, Contact, and Transactional Information (2601), and the second portion being the Anonymized Program Member and Program Information (2605).

The Program Member Personal Identity, Contact, and Transactional Information (2601) includes, but is not limited to, the Program Member's Personal Identity and Contact and/or Address Information (2603), and optionally Payment Transactional Information (2604).

The Program Member's Personal Identity and Contact and/or Address Information (2603) contains the Program Member's full name and, optionally, a participant-chosen username or Program Pseudonym.

Optional Payment Transactional Information (2604) includes Payment Method and/or Source, such as a credit card, payment service, or bank account information. Optional Payment Transaction information (2604), such as a credit card number, may be used temporarily by the Program System to handle payment, and as such may or may not be permanently retained as part of the Program Member's or participant's record.

The Anonymized Program Member and Program Information (2605) portion of a Program Member record, which does not include the Program Member Personal Identity, Contact, and Transactional Information, and which is made available to authorized parties via the Partially Anonymized Program Record Identification Code or Codes (2607) or the Fully Anonymized Program Record Identification Code or Codes (2608), is divided into a plurality of subsections including, but not limited to, the following subsections: Primary or Required Program Member Information (2609), Primary Behavioral, Personal, Behavioral, Social, Situational, Contextual, and Demographic Information (2610), Secondary Program Member Information (2611), Other Information and/or Input (2612), which is further subdivided into Personally Associated Information (2613) and Non-personally Associated Information (2614), and the Program and Performance Record (2615).

The Primary or Required Program Member Information (2609) includes, but is not limited to, ZIP or postal code, gender, and age.

The Primary Behavioral, Personal, Behavioral, Social, Situational, Contextual, and Demographic Information (2610) includes, but is not limited to, the period of time associated with the program-related behavior, current program-related behavioral patterns, history and information on past attempts to modify behavior, current major life events and issues, description of family and social support structures, etc.

The Secondary Behavioral, Personal, Behavioral, Social, Situational, Contextual, and Demographic Information (2611) includes, but is not limited to, marital status, income and other socioeconomic information, admired or trusted figures or sources, history with behavior modification programs for behaviors other than that associated with the program, attitudes, values, choices, affiliations, complaints, etc.

Other Information and/or Input (2612) includes, but is not limited to, information, states, conditions, histories, current events, personal, family, work, and/or social states, status, or situations that might be germane to understanding the whole context of the Program Member, in order to better understand how the Program successfully or unsuccessfully matches the needs of different individuals in terms of efficiency, efficacy, ease, and/or other qualities that can be identified, compared, contrasted, measured, and/or rated.

The first subsection of Other Information and/or Input (2612), Personally-associated Information (2613) includes, but is not limited to, Personal medical and/or health history Family medical and/or health history, and Work history and occupational demographics.

The second subsection of Other Information and/or Input (2612), Non-personally-associated Information (2614), which may be noted and added to the Program Member Record automatically, for purposes of correlating with other information and Program records, includes, but is not limited to, Season of the year, Significant world and/or local events, and Changes to behavior-related products, technologies, laws, etc.

The Program and Performance Record (2615) includes, but is not limited to, the initially-configured or chosen Program Profile and Program Day Schedule Profile, Current Program Profile at a point during the Active Program, Ultimate success or failure of the Program for the Program Member with associated details, a detailed history and/or charitable data record representing all Date/Time-stamped Communication Events/Program Markers, Program Events and Program Member actions, Flags, requests, Program Input Codes, Program changes and dynamic modifications, and all other informational inputs during the Program Member's Active Program.

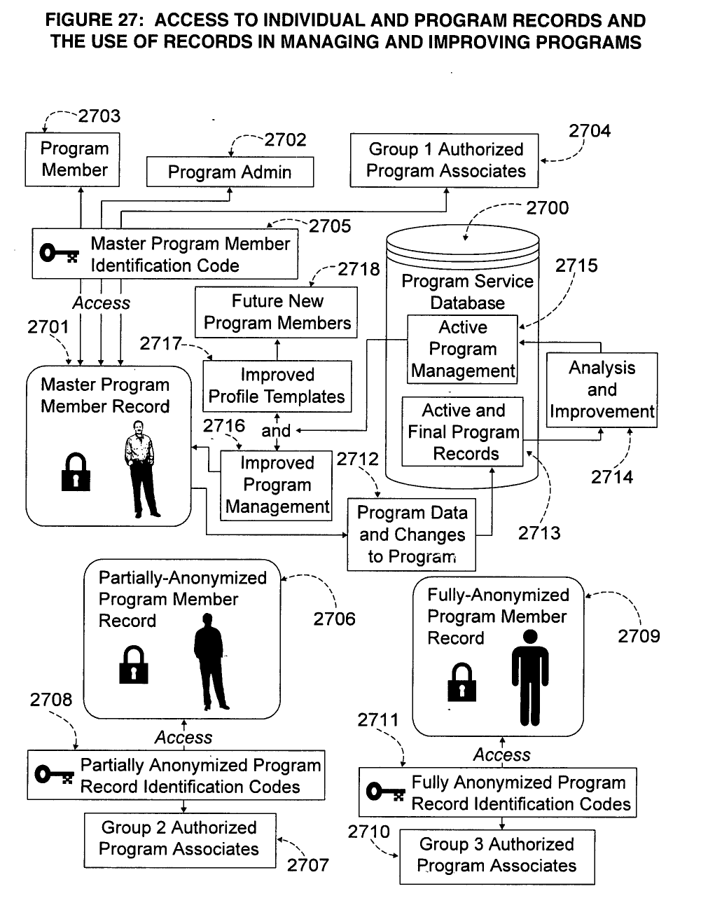

In FIG. 27 it is shown that a complete Master Program Member Program (2701) is stored in the Program Service Database (2700), and is accessible by the Program Member (2703), Program Service (2702), and Group 1 Authorized Program Associates (2704), which includes, but is not limited to, counselors, help line staff, physicians and health professionals, coaches, guides, research entities, or other people, entities, or systems associated with an active Program Member's Program. The Program Member (2703), Program Service Administrators (2702), which are part of the Program Service, but not the Computer Program itself, and Group 1 Authorized Program Associates (2704) may access the Master Program Member's Program Record (2701) via the Master Program Member Identification Code or Codes (2705), which provides privacy and access protection for the Program Member's sensitive, private, and/or personal identification information.

Subsets of the Master Program Member's Program Record (2701), which contain less, or no Program Member personal, private, or identification information includes a Partially Anonymized Program Member Program Record (2706) and a Fully Anonymized Program Member Program Record (2709).

Group 2 Authorized Program Associates, which may include, but are not limited to, counselors, help line staff, physicians and health professionals, coaches, guides, research entities, or other people, entities, or systems associated with an active Program Member's Program, may access a Partially Anonymized Program Member Program Record (2706) via a Partially Anonymized Program Record Identification Code or Codes (2708).

Group 3 Authorized Program Associates, which includes, but is not limited to, Researchers studying aggregated Program Member data, other partners of the Program Service, Advertisers, may access a Fully Anonymized Program Member Program Record (2709) via a Fully Anonymized Program Record Identification Code or Codes (2711).

During an Active Program Calendar Period and, optionally, during an Inactive Program Calendar Period, which may include a period or periods of time following an Active Program Calendar Period, changes to the Program Member's Information, Program Information and/or Active Ongoing, Followup, and/or Final Program Data (2712) is collected, gathered, or otherwise input into the Active and Final Program Member Program Profiles, Demographics, Psycho-graphics, Sociographics, and Program Records (2713) which reside in the Program Service Database (2700).

This data in the Program Member's Program Record may be accessed Program Associates and/or the Program Service System's Computer Program for purposes of Analysis, Design, and Implementation of Improvements or providing informational feedback to the Program Member and, optionally Program Associates (2714).

This may include, but is not limited to, further customization and/or tailoring of the Program Schedule Profile and/or Program Day Schedule Profiles, and informational feedback such as performance records, efficacy, gains or improvements the Program Member is achieving through participation and effort in the Program, and is stored as additions, changes, or updates to the Program Member's Program Profile and Program Day Schedule, and may, optionally, be used to improve or change Program Profile Templates and Active Program Management Actions affecting the overall Program Service System (2715).

Performance records, efficacy, gains or improvements the Program Member is achieving through participation and effort in the Program may include, but are not limited to, financial savings due to decreased spending on a behaviorally-related habit or addiction, such as cigarettes. This information can be made accessible to the Program Member or, optionally, Program Associates, aggregated databases tracking aggregated Program Service performance and/or benefits, or other parties or systems.

Additions, changes, improvements, or updates to Program Profile Templates and/or Active Program Management Actions provide the means to continuously improve Active Program Management Actions (2716) and continuously improved Starting Program Profile and Program Day Profile Templates (2717), aimed at improving the efficacy of the Program and providing benefits for subsequent or future New Program members (2718).

The system and methodology for management and modification of human behavior shown in the drawings and described in detail herein, disclose steps in a process, arrangements of elements of particular construction, and configuration for illustrating preferred embodiments of the system and method of operation of the present invention. It is to be understood, however, that elements of different construction and configuration and different steps and process procedures, and other arrangements thereof, other than those illustrated and described, may be employed for providing the system and method herein within the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A method for human behavior modification implemented by electronic two way communication between a host computing device and a user, comprising the steps of:
(A) collecting registration data regarding a user;
(B) collecting behavior data regarding a behavior requiring modification, and a frequency of said behavior;
C) collecting availability data concerning the available hours of said user during a day to thereby ascertain an active time segment of said user during each said day;
D) utilizing said registration data, said behavior data, and said availability data in a computer process to provide a program profile for each said user, said program profile having a term, and including a tentative schedule for performance of a plurality of sequential events occurring during each said active time segment, on each day, of a plurality of days in said term of said program;
E) adjusting a number of said plurality of sequential events during each said time segment during said plurality of days, depending upon whether said behavior modification is for an increase or a decrease or for a stabilization in a frequency of said behavior;
F) providing a communication to said user, prior to each said event during each said time segment, said communication suggesting said user to engage in said task;
G) providing said user means to communicate an acknowledgment signal, subsequent to receipt of said communication;
H) ascertaining if an acknowledgment signal has been communicated prior to sending a subsequent said communication to said user associated with a subsequent event of said plurality of sequential events;
I) recalculating a replacement timing schedule which redistributes all remaining of said plurality of sequential events allotted to any said time segment, if said user communicates said acknowledgment signal at a time subsequent to the next scheduled subsequent sequential event in said active time segment;
J) repeating steps F through I as needed, until either all of said plurality of said events allotted to a given time segment are acknowledged by a user generated acknowledgment signal, or said active time segment ends, whereby, a customized program profile for each said user can be generated to allot said events during said active time segment available to said user, and, said plurality of events during any said active time segment can be rescheduled in real time, for remaining time in said active time segment, in the event said user communicates said acknowledgment signal for a prior sequential scheduled event at a time after a subsequent scheduled sequential event.

2. The method for human behavior modification of claim 1 additionally comprising the steps of:
(K) after step (F), sending a reminder communication to said user to input said acknowledgment signal, if said user fails to communicate said acknowledgment signal;
(L) repeating steps F through J, and step K as needed, until all of said plurality of said events for a given time segment are completed.

3. The method for human behavior modification of claim 1 additionally comprising the additional steps of:
(M) allowing said user to request an exclusion of a portion of said time segment from said events;
(N) recalculating a second replacement timing schedule for the remaining of said plurality of sequential events still scheduled, during any said time segment for which said exclusion is requested; and
(O) recalculating said plurality of days in said program profile, if needed, based on said exclusion and thereafter repeating step (J).

4. The method for human behavior modification of claim 2 additionally comprising the additional steps of:
(M) allowing said user to request an exclusion of a portion of said time segment from said events;
(N) recalculating a second replacement timing schedule for the remaining of said plurality of sequential events still scheduled, during any said time segment for which said exclusion is requested; and
(O) recalculating said plurality of days in said program profile, if needed, based on said exclusion and thereafter repeating step (J).

5. The method for human behavior modification of claim 1 additionally comprising the additional steps of:
(P) allowing said user to request a change in a length of said active time segment, said change either increasing said active time segment or decreasing said active time segment;
(Q) recalculating a third replacement timing schedule for the remaining of said plurality of sequential events still scheduled, during any said time segment for which said change in length is requested and thereafter repeating step (J).

6. The method for human behavior modification of claim 3 additionally comprising the additional steps of:
(P) allowing said user to request a change in a length of said active time segment, said change either increasing said active time segment or decreasing said active time segment;
Q) recalculating a third replacement timing schedule for the remaining of said plurality of sequential events still scheduled, during any said time segment for which said change in length is requested and thereafter repeating step (J).

7. The method for human behavior modification of claim 4 additionally comprising the additional steps of:
(P) allowing said user to request a change in a length of said active time segment, said change either increasing said active time segment or decreasing said active time segment;
Q) recalculating a third replacement timing schedule for the remaining of said plurality of sequential events still scheduled, during any said time segment for which said change in length is requested and thereafter repeating step (J).

8. The method for human behavior modification of claim 1 additionally comprising the additional steps of:
R) allowing said user to request a plateau in the program profile, said plateau being for one or a plurality of extra days during which said plurality of sequential events allotted to each said active time segment is equal;
S) increasing the plurality of days in said program profile by the amount of said plurality of extra days.

9. The method for human behavior modification of claim 2 additionally comprising the additional steps of:
R) allowing said user to request a plateau in the program profile, said plateau being for one or a plurality of extra days during which said plurality of sequential events allotted to each said active time segment is equal;
(S) increasing the plurality of days in said program profile by the amount of said plurality of extra days.

10. The method for human behavior modification of claim 3 additionally comprising the additional steps of:
R) allowing said user to request a plateau in the program profile, said plateau being for one or a plurality of extra days during which said plurality of sequential events allotted to each said active time segment is equal;
(S) increasing the plurality of days in said program profile by the amount of said plurality of extra days.

11. The method for human behavior modification of claim 4 additionally comprising the additional steps of:
R) allowing said user to request a plateau in the program profile, said plateau being for one or a plurality of extra days during which said plurality of sequential events allotted to each said active time segment is equal;
(S) increasing the plurality of days in said program profile by the amount of said plurality of extra days.

12. The method for human behavior modification of claim 5 additionally comprising the additional steps of:
R) allowing said user to request a plateau in the program profile, said plateau being for one or a plurality of extra days during which said plurality of sequential events allotted to each said active time segment is equal;
(S) increasing the plurality of days in said program profile by the amount of said plurality of extra days.

13. The method for human behavior modification of claim 6 additionally comprising the additional steps of:
R) allowing said user to request a plateau in the program profile, said plateau being for one or a plurality of extra days during which said plurality of sequential events allotted to each said active time segment is equal;
(S) increasing the plurality of days in said program profile by the amount of said plurality of extra days.

14. The method for human behavior modification of claim 7 additionally comprising the additional steps of:
R) allowing said user to request a plateau in the program profile, said plateau being for one or a plurality of extra days during which said plurality of sequential events allotted to each said active time segment is equal;
(S) increasing the plurality of days in said program profile by the amount of said plurality of extra days.

15. The method for human behavior modification of claim 1 additionally comprising the additional steps of:
(T) allowing a banking of at least one of said sequential events as a banked event for performance at a later time in said time segment of the user's choosing; and
(U) allowing a communication for withdrawal of any said banked event at any time in said term of said program thereafter.

16. The method for human behavior modification of claim 3 additionally comprising the additional steps of:
(T) allowing a banking of at least one of said sequential events as a banked event for performance at a later time in said time segment of the user's choosing; and
(U) allowing a communication for withdrawal of any said banked event at any time in said term of said program thereafter.

17. The method for human behavior modification of claim 6 additionally comprising the additional steps of:
(T) allowing a banking of at least one of said sequential events as a banked event for performance at a later time in said time segment of the user's choosing; and
(U) allowing a communication for withdrawal of any said banked event at any time in said term of said program thereafter.

18. The method for human behavior modification of claim 13 additionally comprising the additional steps of:
(T) allowing a banking of at least one of said sequential events as a banked event for performance at a later time in said time segment of the user's choosing; and
(U) allowing a communication for withdrawal of any said banked event at any time in said term of said program thereafter.

19. The method for human behavior modification of claim 1 additionally comprising the additional steps of:
(V) allowing the user to request a start of said active time segment at an earlier time on a said day than scheduled thereby creating an increased active time segment; and
(W) redistributing said plurality of sequential events allotted for said time segment to appropriately fill said increased active time segment.

20. The method for human behavior modification of claim 3 additionally comprising the additional steps of:
(V) allowing the user to request a start of said active time segment at an earlier time on a said day than scheduled thereby creating an increased active time segment; and
(W) redistributing said plurality of sequential events allotted for said time segment to appropriately fill said increased active time segment.

21. The method for human behavior modification of claim 6 additionally comprising the additional steps of:
(V) allowing the user to request a start of said active time segment at an earlier time on a said day than scheduled thereby creating an increased active time segment; and
(W) redistributing said plurality of sequential events allotted for said time segment to appropriately fill said increased active time segment.

22. The method for human behavior modification of claim 13 additionally comprising the additional steps of:
(V) allowing the user to request a start of said active time segment at an earlier time on a said day than scheduled thereby creating an increased active time segment; and
(W) redistributing said plurality of sequential events scheduled during said time segment to appropriately fill said increased active time segment.

23. The method for human behavior modification of claim 18 additionally comprising the additional steps of:
(V) allowing the user to request a start of said active time segment at an earlier time on a said day than scheduled thereby creating an increased active time segment; and
(W) redistributing said plurality of sequential events scheduled during said time segment to appropriately fill said increased active time segment.

24. The method for human behavior modification of claim 1 additionally comprising the additional steps of:
(X) allowing the user, at any time during said term of said program, to request an increase or a decrease in the number of said plurality of sequential events in said active time segment of said program profile; and
(Y) recalculating said program profile to adapt said timing schedule for performance of each of said plurality of sequential events occurring during each said active time segment, on each day subsequent to said requested increase or decrease in said sequential events.

25. The method for human behavior modification of claim 3 additionally comprising the additional steps of:
(X) allowing the user, at any time during said term of said program, to request an increase or a decrease in the number of said plurality of sequential events in said active time segment of said program profile; and
(Y) recalculating said program profile to adapt said timing schedule for performance of each of said plurality of sequential events occurring during each said active time segment, on each day subsequent to said requested increase or decrease in said sequential events.

26. The method for human behavior modification of claim 6 additionally comprising the additional steps of:
(X) allowing the user, at any time during said term of said program, to request an increase or a decrease in the number of said plurality of sequential events in said active time segment of said program profile; and
(Y) recalculating said program profile to adapt said timing schedule for performance of each of said plurality of sequential events occurring during each said active time segment, on each day subsequent to said requested increase or decrease in said sequential events.

27. The method for human behavior modification of claim 13 additionally comprising the additional steps of:
(X) allowing the user, at any time between said term of said program, to request an increase or a decrease in the number of said plurality of sequential events in said active time segment of said program profile; and
(Y) recalculating said program profile to adapt said timing schedule for performance of each of said plurality of sequential events occurring during each said active time segment, on each day subsequent to said requested increase or decrease in said sequential events.

28. The method for human behavior modification of claim 18 additionally comprising the additional steps of:
(X) allowing the user, at any time between said term of said program, to request an increase or a decrease in the number of said plurality of sequential events in said active time segment of said program profile; and
(Y) recalculating said program profile to adapt said timing schedule for performance of each of said plurality of sequential events occurring during each said active time segment, on each day subsequent to said requested increase or decrease in said sequential events.

29. The method for human behavior modification of claim 22 additionally comprising the additional steps of:
(X) allowing the user, at any time between said term of said program, to request an increase or a decrease in the number of said plurality of sequential events in said active time segment of said program profile; and
(Y) recalculating said program profile to adapt said timing schedule for performance of each of said plurality of sequential events occurring during each said active time segment, on each day subsequent to said requested increase or decrease in said sequential events.

30. The method for human behavior modification of claim 29 additionally comprising:
said behavior modification being the cessation of smoking by said user wherein said sequential events are for a task of smoking and are diminished in frequency during each subsequent active time segment for said term.

31. The method for human behavior modification of claim 1 additionally comprising:
collecting said registration data and said behavior data and said availability data, through provision of a software interface communicated over a network from a host computer to a remote user communication device.

32. The method for human behavior modification of claim 31 additionally comprising the steps of:
anonymizing said registration data, said behavior data, and said availability data from multiple said users who are employing the method for human behavior modification for a similar reason, and storing it in a collective database; and
employing said collective database for study of the behavior.

33. The method of claim 1 including the step of:
delivering each said communication to said user via an electronic communication medium.

34. The method of claim 33 wherein said electronic communication medium is selected from the group consisting of text messaging, facsimile, e-mail, and internet communication.

35. The method for human behavior modification of claim 1 additionally comprising the additional steps of:
(Z) providing said user, means to communicate information at any time during said active day schedule.

36. The method for human behavior modification of claim 3 additionally comprising the additional steps of:
(Z) providing said user, means to communicate information at any time during said active day schedule.

37. The method for human behavior modification of claim 6 additionally comprising the additional steps of:
(Z) providing said user, means to communicate information at any time during said active day schedule.

38. The method for human behavior modification of claim 13 additionally comprising the additional steps of:
(Z) providing said user, means to communicate information at any time during said active day schedule.

39. The method for human behavior modification of claim 18 additionally comprising the additional steps of:
(Z) providing said user, means to communicate information at any time during said active day schedule.

40. The method for human behavior modification of claim 22 additionally comprising the additional steps of:
(Z) providing said user, means to communicate information at any time during said active day schedule.

41. The method for human behavior modification of claim 29 additionally comprising the additional steps of:
(Z) providing said user, means to communicate information at any time during said active day schedule.

42. The method for human behavior modification of claim 1 additionally comprising the additional steps of:
Employing a shaping function to change a sequential increase or decrease in said number of said plurality of sequential events during each said time segment during said plurality of days, said shaping function resulting in one of a group of shaping including,
a steeper reduction of said plurality of sequential events during each said time segment at the beginning of the Program and becoming less steep for the remainder of the term of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles from the for the term of said program having a straighter overall slope of reduction in said plurality of sequential events during each said time segment throughout the program, or
successive cycles for the term of said program each said cycle having substantially straight linear segments with each successive substantially straight linear segment having a lessening rate of reduction in said plurality of sequential events during each said time segment.

43. The method for human behavior modification of claim 3 additionally comprising the additional steps of:
Employing a shaping function to change a sequential increase or decrease in said number of said plurality of sequential events during each said time segment during said plurality of days, said shaping function resulting in one of a group of shaping including,
a steeper reduction of said plurality of sequential events during each said time segment at the beginning of the Program and becoming less steep during the term of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles for the term of said program, having a straighter overall slope of reduction in said plurality of sequential events during each said time segment throughout the program, or
successive cycles for the term of said program each said cycle having substantially straight linear segments with each successive substantially straight linear segment having a lessening rate of reduction in said plurality of sequential events during each said time segment.

44. The method for human behavior modification of claim 6 additionally comprising the additional steps of:
Employing a shaping function to change a sequential increase or decrease in said number of said plurality of sequential events during each said time segment during said plurality of days, said shaping function resulting in one of a group of shaping including,
a steeper reduction of said plurality of sequential events during each said time segment at a beginning of the Program and becoming less steep for the term of said program of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles from a beginning of said program each said cycle, having a straighter overall slope of reduction in said plurality of sequential events during each said time segment throughout the program, or
successive cycles from the beginning of said program with each said cycle having substantially straight linear segments with each successive substantially straight linear segment having a lessening rate of reduction in said plurality of sequential events during each said time segment.

45. The method for human behavior modification of claim 13 additionally comprising the additional steps of:
a steeper reduction of said plurality of sequential events during each said time segment at a beginning of the Program and becoming less steep for the term of said program of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles from a beginning of said program each said cycle, having a straighter overall slope of reduction in said plurality of sequential events during each said time segment throughout the program, or
successive cycles from the beginning of said program with each said cycle having substantially straight linear segments with each successive substantially straight linear segment having a lessening rate of reduction in said plurality of sequential events during each said time segment.

46. The method for human behavior modification of claim 18 additionally comprising the additional steps of:
a steeper reduction of said plurality of sequential events during each said time segment at a beginning of the Program and becoming less steep for the term of said program of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles from a beginning of said program each said cycle, having a straighter overall slope of reduction in said plurality of sequential events during each said time segment throughout the program, or
successive cycles from the beginning of said program with each said cycle having substantially straight linear segments with each successive substantially straight linear segment having a lessening rate of reduction in said plurality of sequential events during each said time segment.

47. The method for human behavior modification of claim 35 additionally comprising the additional steps of:
a steeper reduction of said plurality of sequential events during each said time segment at a beginning of the Program and becoming less steep for the term of said program of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles from a beginning of said program each said cycle, having a straighter overall slope of reduction in said plurality of sequential events during each said time segment throughout the program, or
successive cycles from the beginning of said program with each said cycle having substantially straight linear segments with each successive substantially straight linear segment having a lessening rate of reduction in said plurality of sequential events during each said time segment.

48. The method for human behavior modification of claim 41 additionally comprising the additional steps of:
a steeper reduction of said plurality of sequential events during each said time segment at a beginning of the Program and becoming less steep for the term of said program of the program, or
successive cycles in said program each said cycle beginning with a gradual increase of the steepness a rate of reduction in said plurality of sequential events during each said time segment until said cycle ceases and a successive cycle begins with a next gradual increase in the rate of reduction said plurality of sequential events during each said time segment, or
successive cycles in said program each said cycle beginning with an increase of the steepness a rate of reduction in said plurality of sequential events during each said time segment until said cycle ceases and a successive cycle begins with the steepest rate of reduction said plurality of sequential events during each said time segment, or
successive cycles from a beginning of said program each said cycle, having a straighter overall slope of reduction in said plurality of sequential events during each said time segment throughout the program, or
successive cycles from the beginning of said program with each said cycle having substantially straight linear segments with each successive substantially straight linear segment having a lessening rate of reduction in said plurality of sequential events during each said time segment.
